(19) United States
(12) Patent Application Publication
(10) Pub. No.: US 2016/0125157 A1
(43) Pub. Date: May 5, 2016

(54) Systems and Methods to Monitor Health of Online Social Communities

(71) Applicant: Lithium Technologies, Inc., San Francisco, CA (US)

(72) Inventor: Michael Wu, Oakland, CA (US)

(21) Appl. No.: 14/929,209

(22) Filed: Oct. 30, 2015

Related U.S. Application Data
(60) Provisional application No. 62/072,929, filed on Oct. 30, 2014.

(51) Int. Cl. G06F 19/00; G06Q 50/00

(52) U.S. Cl. CPC G06F 19/3431; G06F 19/322; G06Q 50/01

(57) ABSTRACT

A method of measuring the health of online communities computes multiple health factors for an online community. Each health factor is computed based on historical data of the online community, and each health factor measures human interaction with the online community. The process normalizes each of the health factors and combines the health factors to compute a community health index. The process then displays the community health index to a user, thereby enabling the user to predict the future health of the online community. The health index includes various factors, such as: growth in membership of the online community; human page views of web pages for the online community; quantity and quality of posts to the online community; liveliness of the online community; interaction with the online community; and/or responsiveness of the online community.

### RELATED APPLICATION

This application claims priority to U.S. Provisional Application Ser. No. 62/072,929, filed Oct. 30, 2014, entitled “Systems and Methods to Monitor Health of Online Social Communities,” which is incorporated by reference herein in its entirety.

### TECHNICAL FIELD

The disclosure relates generally to monitoring and predicting the health of an online community.

### BACKGROUND

Customer communities are starting to become an integral part of most enterprises. IDC predicts that by 2017, 80% of Fortune 500 companies will have an active customer community. Consequently it is important to measure the performance and vibrancy of a community. The traditional approach involves looking at many individual metrics in isolation. However, simple activity-counter metrics, in isolation, are often insufficient to give a big picture, because a community has so many moving parts. Moreover, optimizing one set of metrics can inadvertently hurt other metrics.

### SUMMARY

A disclosed community health index (CHI) is a single score that allows a user to quickly gauge how a community is doing. The disclosed community health index includes multiple health factor scores, such as traffic, content, membership, liveliness, interaction, and responsiveness. This is a powerful diagnostic tool because whenever CHI drops, community administrators can examine the health factor scores to figure out the problem. Furthermore, the drill down capability allows community managers to identify which part of the community is causing the problem. Some implementations prescribe a course of action to alleviate the problem.

Disclosed are methods for creating and maintaining a vibrant and resilient online social community.

People participate in social media communities to share their interests, to provide recommendations and preferences, and to look for help or advice from their peers. These online communities in turn have provided businesses ways to cut down on costs related to product support and to provide brand marketing and advocacy. It is useful for businesses to maintain vibrant and resilient communities where people can continually participate and share their experiences about products and/or services. This disclosure presents methods for maintaining vibrancy and resiliency for an online social community.

In some implementations, the methods include: (a) measuring specific activities within an online community and storing the data as activity metrics; (b) computing several Community Health Index factors, where distinct sets of activity metrics are grouped to compute each aggregated factor, and the factors are further aggregated to compute an overall Community Health Index; (c) defining a set of tolerance levels to monitor for each of the aggregated Community Health Index factors, which specify when a community manager should take action; and (d) defining a set of actions to take to remedy problems associated with any aggregated Community Health Index factor.

Previously, community managers tasked with keeping a community vibrant would have to examine many individual metrics (e.g., 10-50 metrics). By optimizing one metric, they may end up hurting another metric. Disclosed systems and methods provide a holistic view of community health and provide drill down capability. With this, community managers can focus on the recommendations that make a community healthy rather than figuring out what is wrong with the community.

In accordance with some implementations, a method of measuring the health of online communities is performed at a computing device (e.g., one or more servers 1000) having one or more processors and memory. The memory stores one or more programs configured for execution by the one or more processors. The process computes a plurality of health factors for an online community. Each health factor is computed based on historical data of the online community, and each health factor measures human interaction with the online community. The process normalizes each of the health factors and combines the health factors to compute a community health index. The process then displays the community health index to a user on a display associated with the computing device, thereby enabling the user to predict the future health of the online community.

In some implementations, the plurality of health factors includes one or more of: (1) growth in membership of the online community; (2) human page views of web pages for the online community; (3) quantity and quality of posts to the online community; (4) liveliness of the online community; (5) interaction with the online community; and (6) responsiveness of the online community.

In some implementations, the plurality of health factors includes a health factor that tracks a growth rate of members registered with the online community.

In some implementations, the plurality of health factors includes a health factor that tracks a number of pages views of web pages in the online community.

In some implementations, the plurality of health factors includes a health factor that estimates quantity and quality of posts to the online community by computing a product of a first number representing number of posts to the online community and a second number representing number of page views of web pages in the online community.

In some implementations, the plurality of health factors includes a health factor that measures liveliness of the online community. In some implementations, liveliness is computed as a function whose argument is number of posts to the online community divided by number of boards in the online community. In some implementations, the function includes a second argument that represents an expected number of posts per board during a specified unit of time.

In some implementations, the plurality of health factors includes a health factor that measures interaction of the online community. In some implementations, interaction is computed as an aggregated function of posting threads, including both the number of replies in each thread and the number of distinct users in each thread.

In some implementations, the plurality of health factors includes a health factor that measures responsiveness of the online community. In some implementations, responsiveness is computed as an average response time in posting threads.

In some implementations, normalizing each of the health factors includes applying a statistical distribution model.

In some implementations, normalizing each of the health factors includes computing a quantile for each health factor that ranks the health factor for the online community against other online communities.

In some implementations, combining the health factors to compute a community health index uses a generalized mean function of the plurality of health factors.

In some implementations, combining the health factors to compute a community health index uses a weighted average of the plurality of health factors.

In some implementations, combining the health factors to compute a community health index scales the computed value to a specific range.

In some implementations, displaying the community health index includes providing a user interface shat shows both the community health index and the individual health factors that were used to compute the community health index.

In some implementations, displaying the community health index includes providing a user interface that shows a graph of how the community health index has changed over time.

In accordance with some implementations, a computing device includes one or more processors and memory. The memory stores one or more programs configured for execution by the one or more processors. The one or more programs include instructions for performing any of the methods described above.

In accordance with some implementations, a non-transitory computer readable storage medium stores one or more programs configured for execution by a computing device having one or more processors and memory. The one or more programs include instructions for performing any of the methods described above.

### BRIEF DESCRIPTION OF THE DRAWINGS

FIGS. 1-9 illustrate a statistical modeling framework for computing a community health index in accordance with some implementations.

FIGS. 10-20 illustrate some of the health factors (HFs) that may be used to compute a community health index in accordance with some implementations.

FIGS. 21-27 illustrate computing health factor scores using various statistical models in accordance with some implementations.

FIG. 28 illustrates some ways of combining individual health factors or health factor scores to compute an overall community health index, in accordance with some implementations.

FIGS. 29-40 illustrate user interfaces that can be used to view and understand community health in accordance with some implementations.

FIG. 41 is a block diagram illustrating a server that may be used to compute a community health index in accordance with some implementations.

FIG. 42 is a block diagram illustrating a user computing device that can be used to review the health of an online community or to participate in an online community in accordance with some implementations.

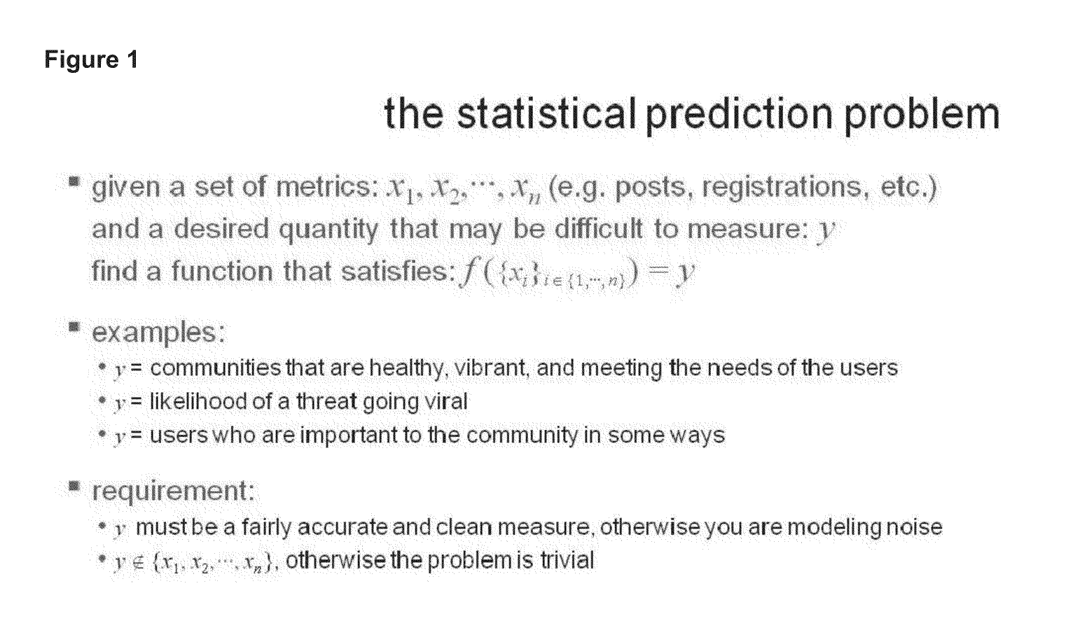

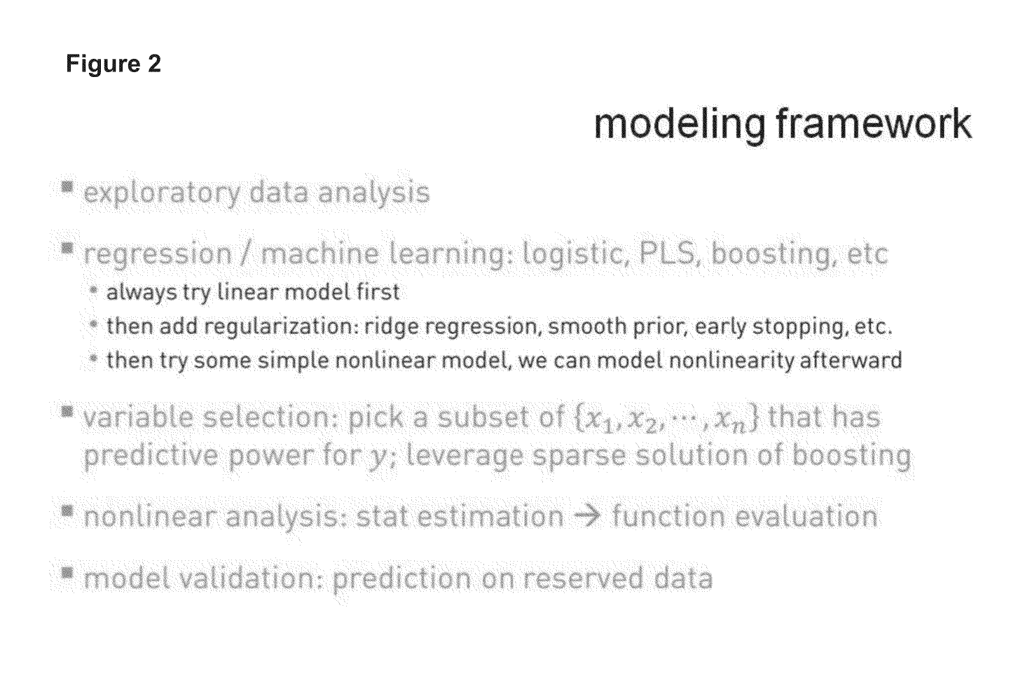

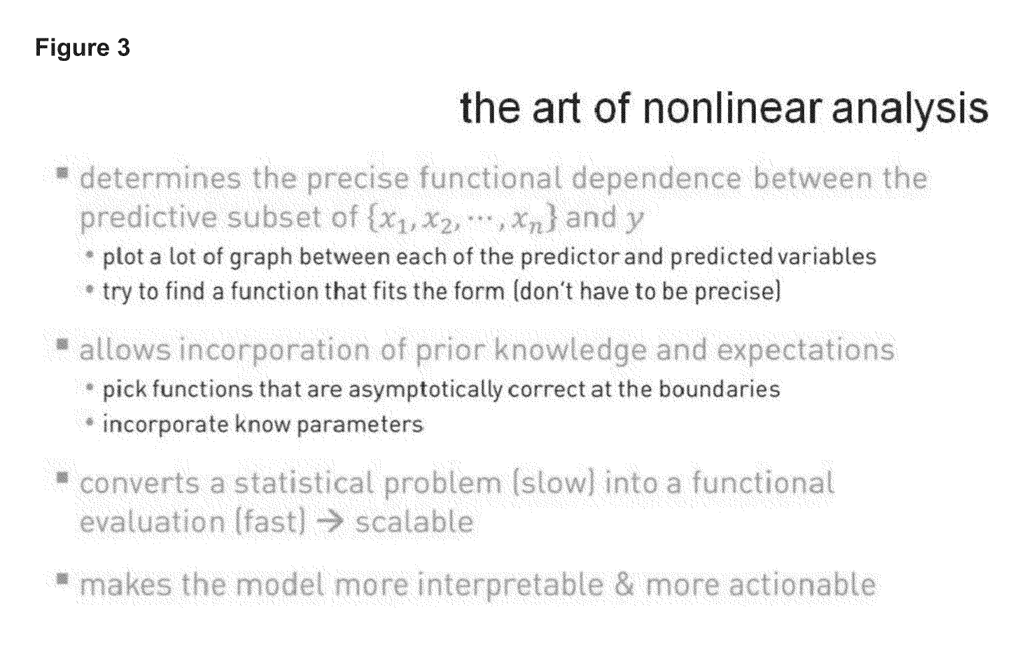

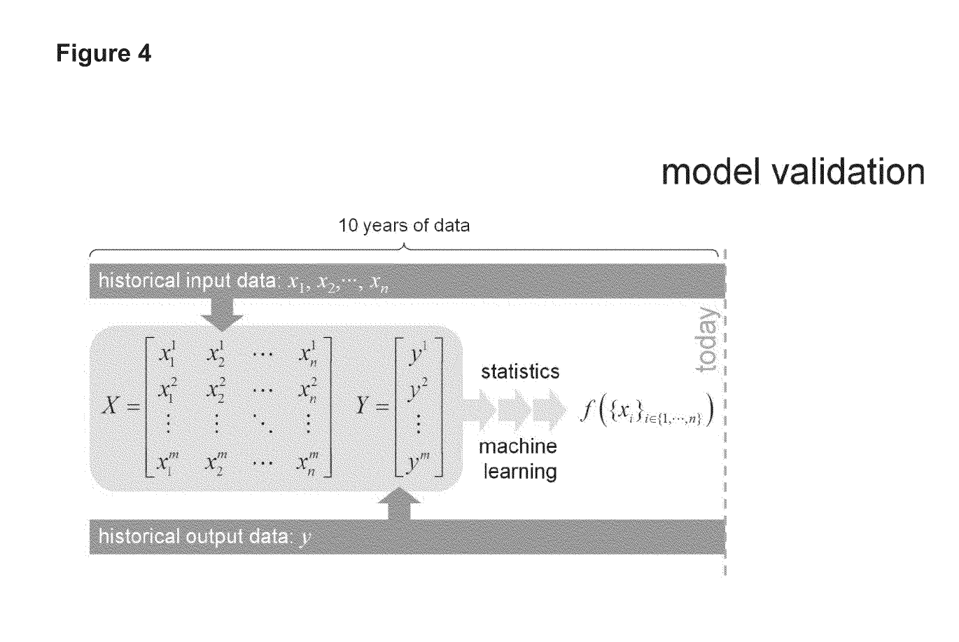

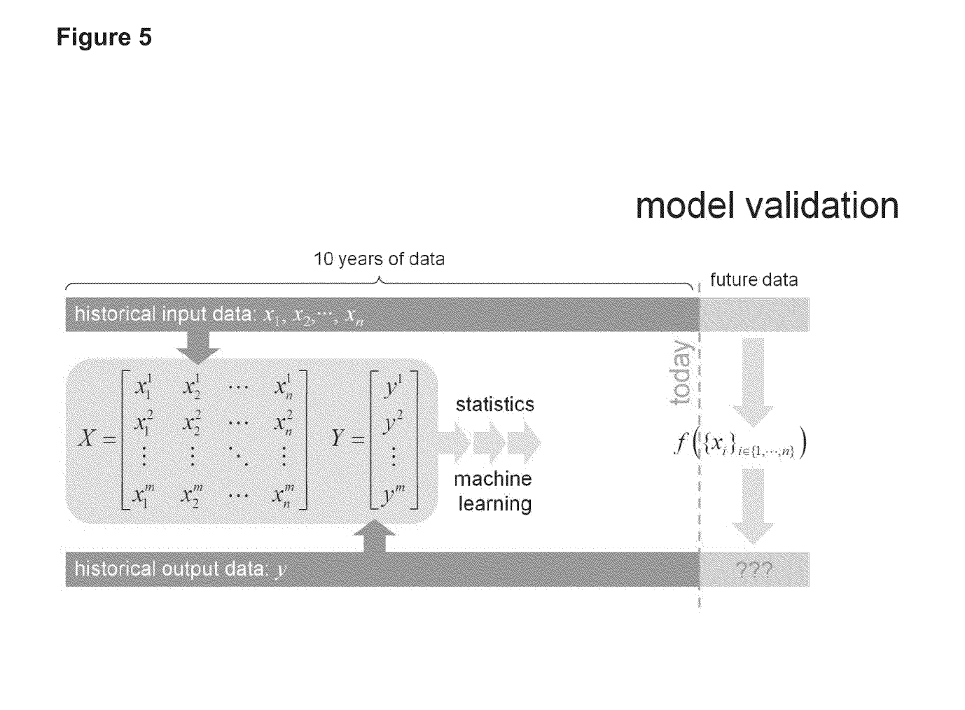

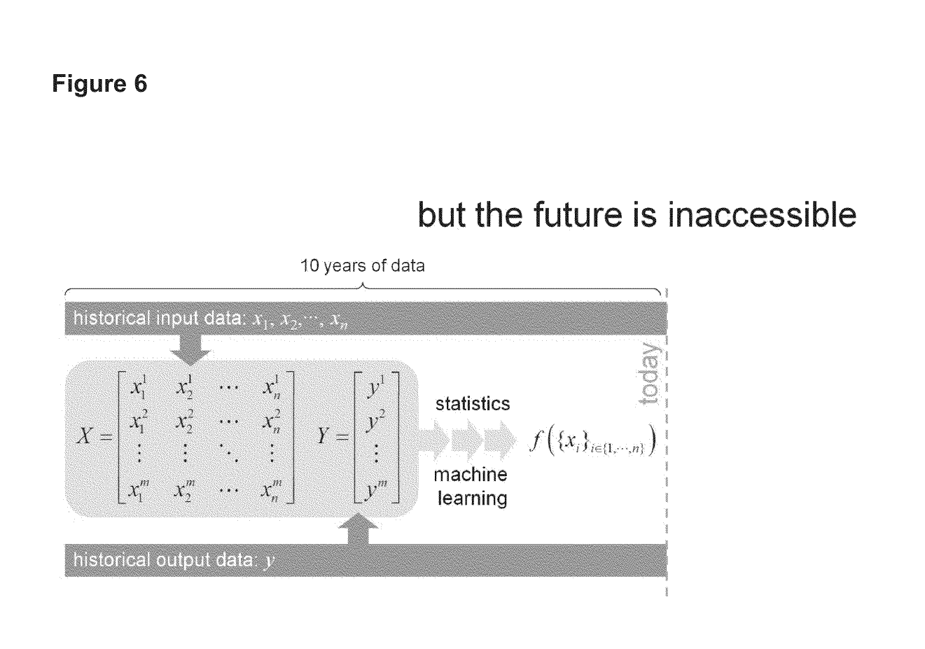

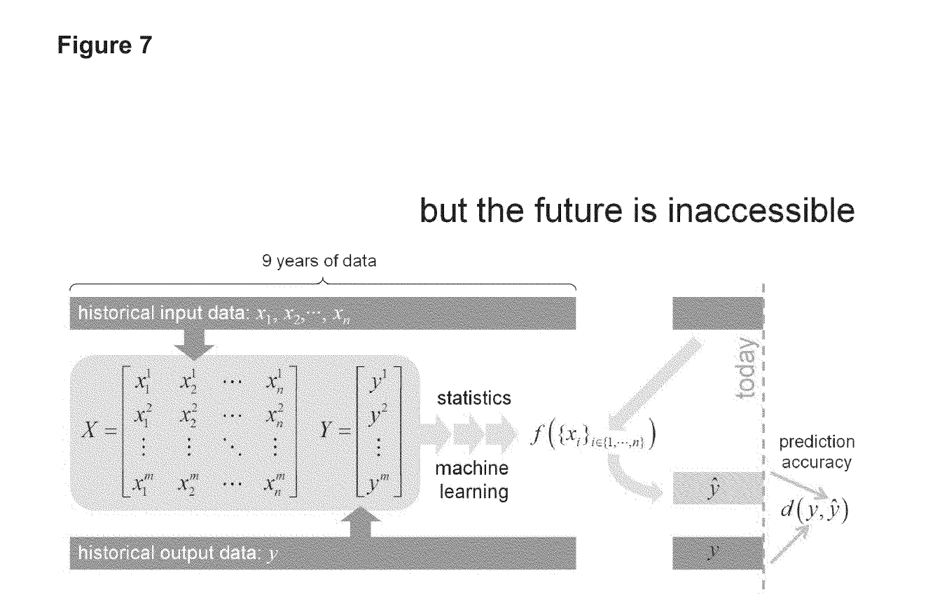

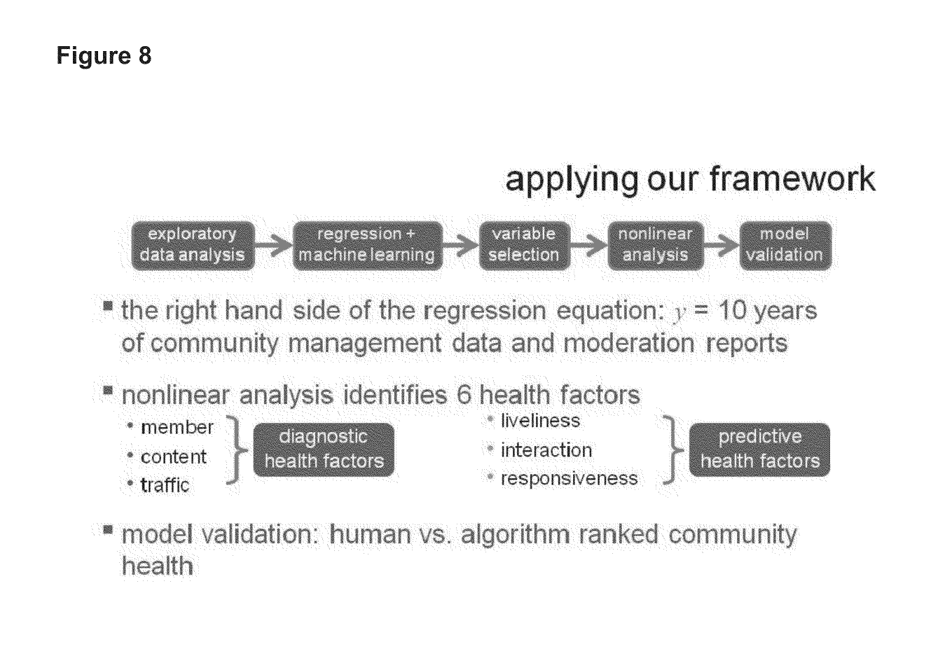

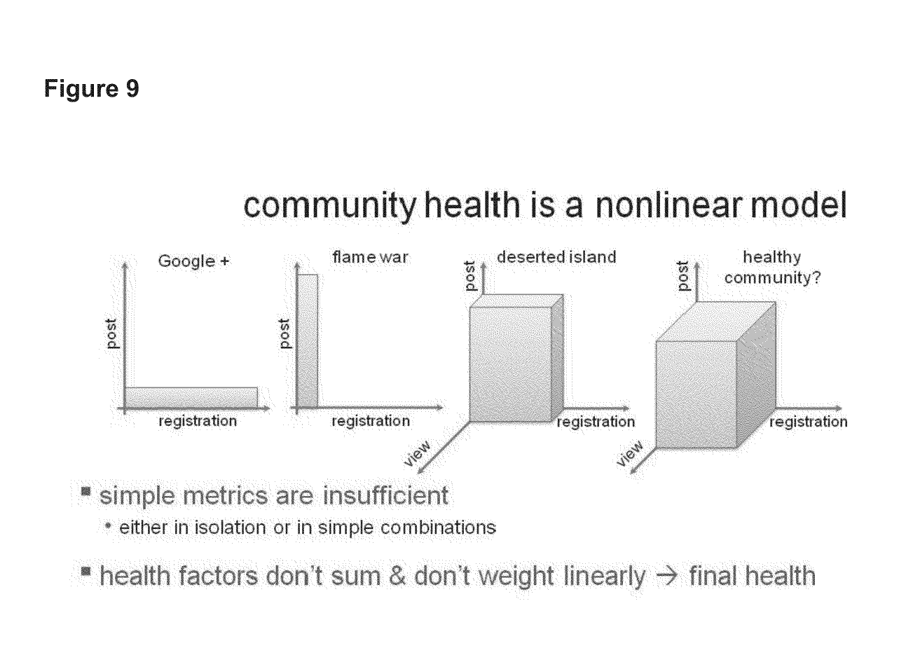

### DESCRIPTION OF IMPLEMENTATIONS

Disclosed implementations provide methods and systems for computing the health of an online community, both retrospectively and prospectively. Implementations compute a community health index (CHI), which can be compared against other communities or historical values for the same community. Because of the acronym CHI, the community health index is sometimes represented by the Greek letter χ.

Some implementations for computing a community health index have been built on data warehouse technology, where the metrics that are used as input to the CHI algorithms are stored in mySQL tables. This solution uses simple counters that count when certain code sequences are reached or executed. These metrics are prone to interpretation errors because there is little contextual data available. In addition, such a process typically does not scale well.

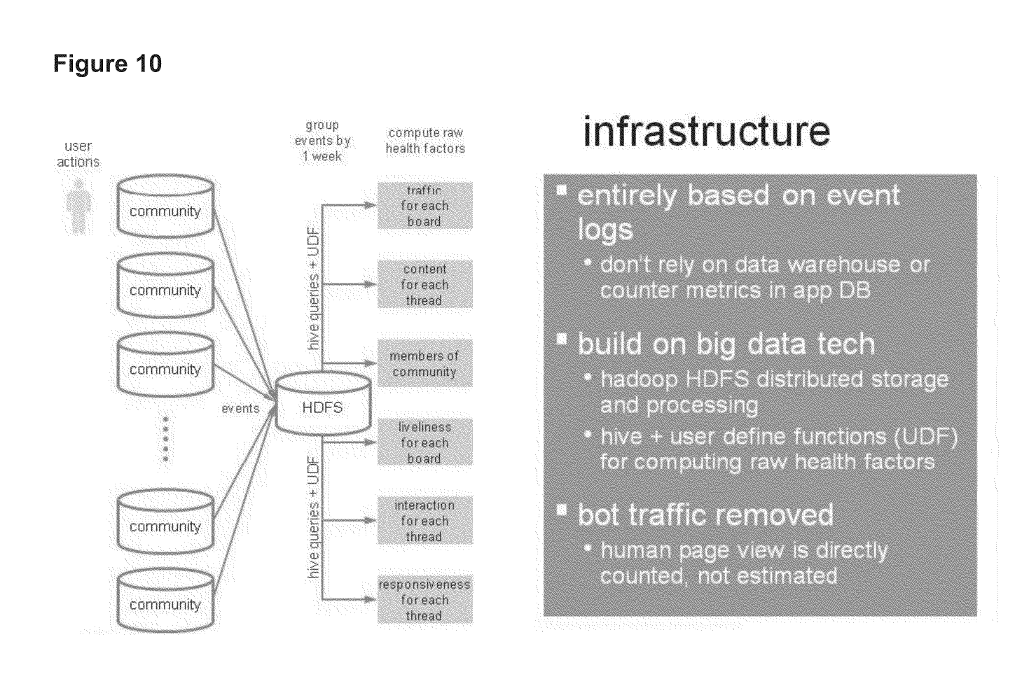

As illustrated in FIG. 10, some implementations utilize modern big data technologies (e.g., Hadoop and Hive). These implementations are based on events. When a user takes an action, an event describing that action is created. The events are created individually over time as they occur, so it does not degrade the performance of the application. Each event includes substantial contextual information about the action that the user took. For example, this may include the server request ID, the session ID, the IP address, the user agent, the requested URL, various query parameters, referrers, the community ID, the action ID, a timestamp, an indication of where within the community the action was taken, who took the action, the target object of that action, who was the receiver of the action, and so on.

In some implementations, the events are stored as text strings in a Hadoop Distributed File System (HDFS). Some implementations derive the metrics that are used to compute CHI from these events using Hive and user defined functions (UDFs).

Because each event includes the user agent string, implementations can determine whether a page view action was initiated by an automated bot or by a human (e.g., using the WURFL package). The human contributed page views are aggregated and used as the input to a “traffic” health factor in some community health index computations.

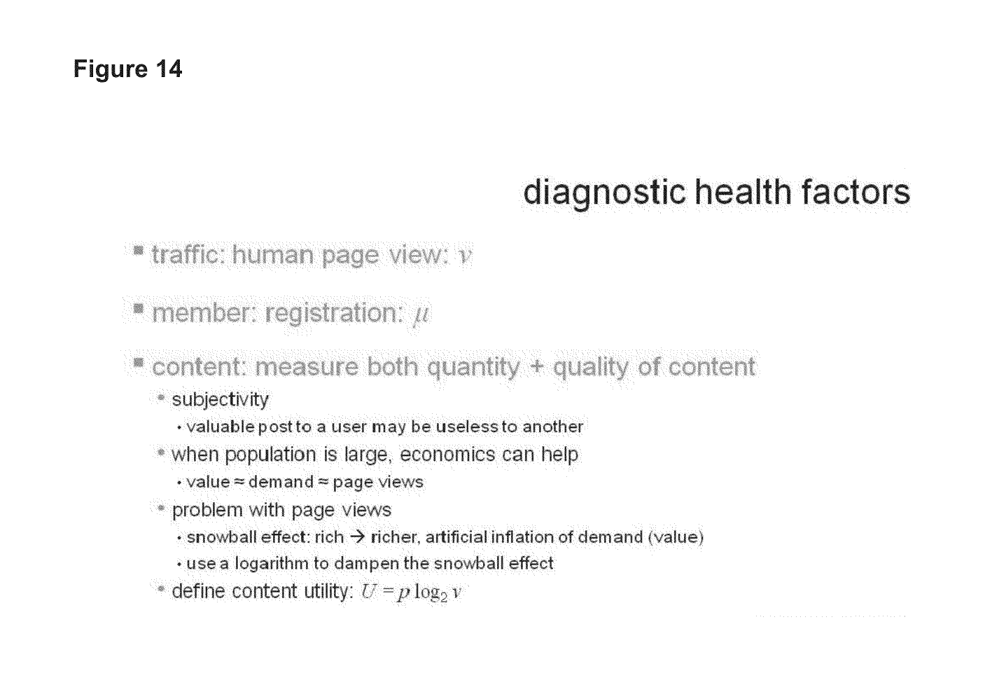

As illustrated in FIG. 14, some implementations compute content utility using the formula U=p log₂ v, where p=the number of posts in a certain period of time and v=the number of human page views in the same period of time. In some implementations, all events are grouped into 1 week periods before computing the health factors. Each of the health factors is computed for each week period.

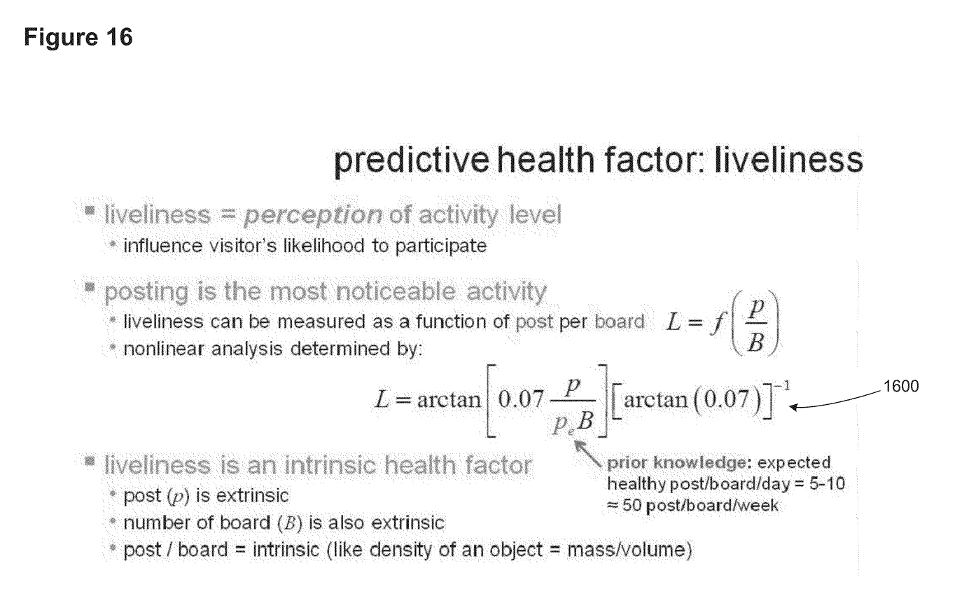

FIG. 16 illustrate one formula 1600 that is used by the liveliness module 1048 in some implementations to compute the liveliness of an online social community. In this example, p is the number of posts (e.g, during a one week period), and B is the number of boards. The ratio p/B is the average number of posts per board, which can be compared to a known expected number of posts per board pₑ for the same period of time. The quantity

$$\frac{p}{{p}_{e} B}$$

is 1 when the posts per board is at the average for a healthy online community, is greater than 1 when the posts per board is above average, and is less than 1 when the posts per board is less than average. In particular, the computed value for L in the formula 1600 is 1 when the posts per board is average.

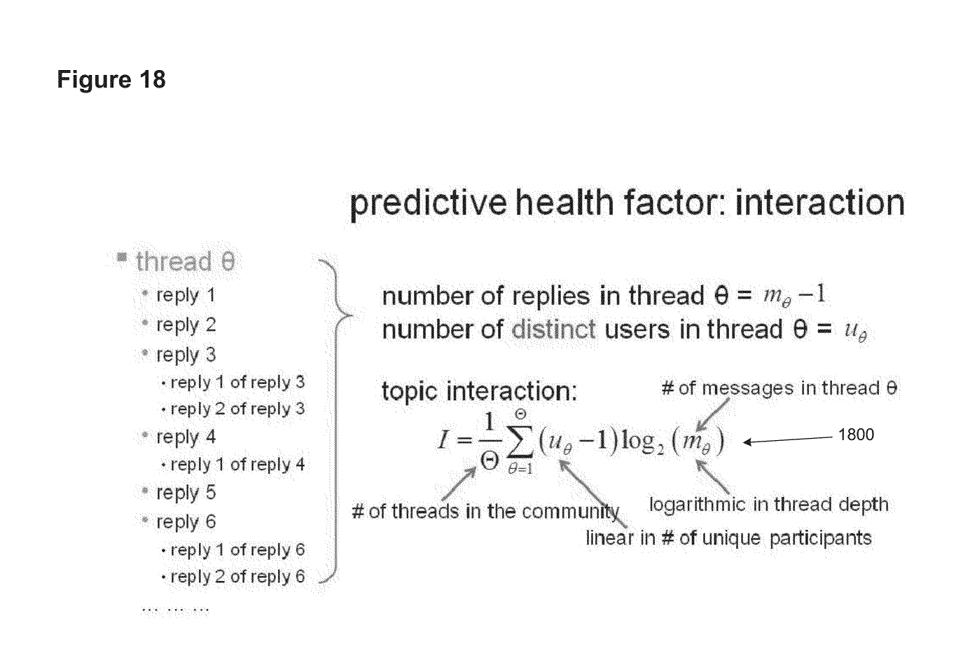

FIG. 18 illustrates one formula 1800 that is used by the interaction module 1050 in some implementations to compute interaction within an online community. A thread is identified by the Greek letter θ. The number of messages in a thread is m_{θ}, which includes the original message plus m_{θ}−1 reply messages. The number of distinct users in a thread is denoted u_{θ}. Here, the capital Greek letter Θ denotes the total number of threads in the community. Using this information the formula 1800 computes an average interaction I for the community.

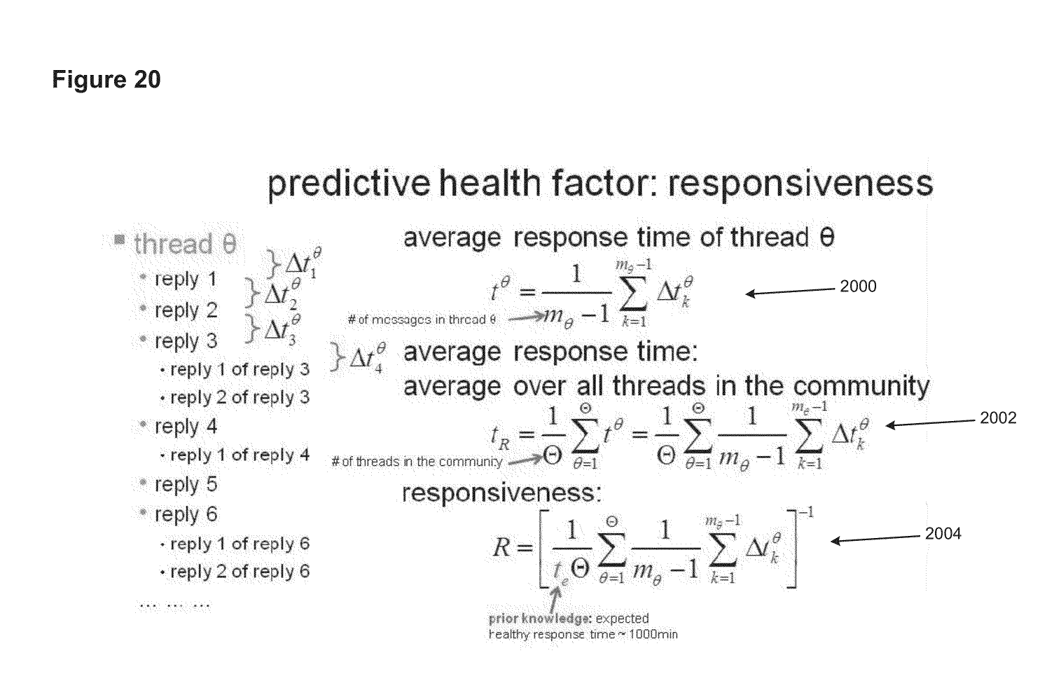

FIG. 20 provides some formulas that are used by the responsiveness module 1052 to compute the responsiveness of an online community according to some implementations. The first formula 2000 computes the average response time within a single thread θ. With m_{θ} posts within the thread, there are m_{θ}−1 responses. Here, the quantity Δtₖ^{θ}, is the amount of time for the kth response as measured from the most recent response (or time from the original post for k=1). The first formula 2000 computes t^{θ}, which is the average of these response times.

The second formula 2002 computes the average t_{R} of the response times over all threads, where Θ again denotes the total number of threads. In this example, the average weights all of the threads equally, but in some implementations, the threads are weighted differently. For example, in some implementations, threads that are longer are weighted more heavily. In some implementations, the weights are based on content analysis of the threads.

The third formula 2004 computes the responsiveness R of the community by comparing the average response time t_{R} to an expected healthy response time tₑ. Because lower response times indicate better health, the formula computes

$$= {( \frac{{t}_{R}}{{t}_{e}} )}^{- 1} = \frac{{t}_{e}}{{t}_{R}} .$$

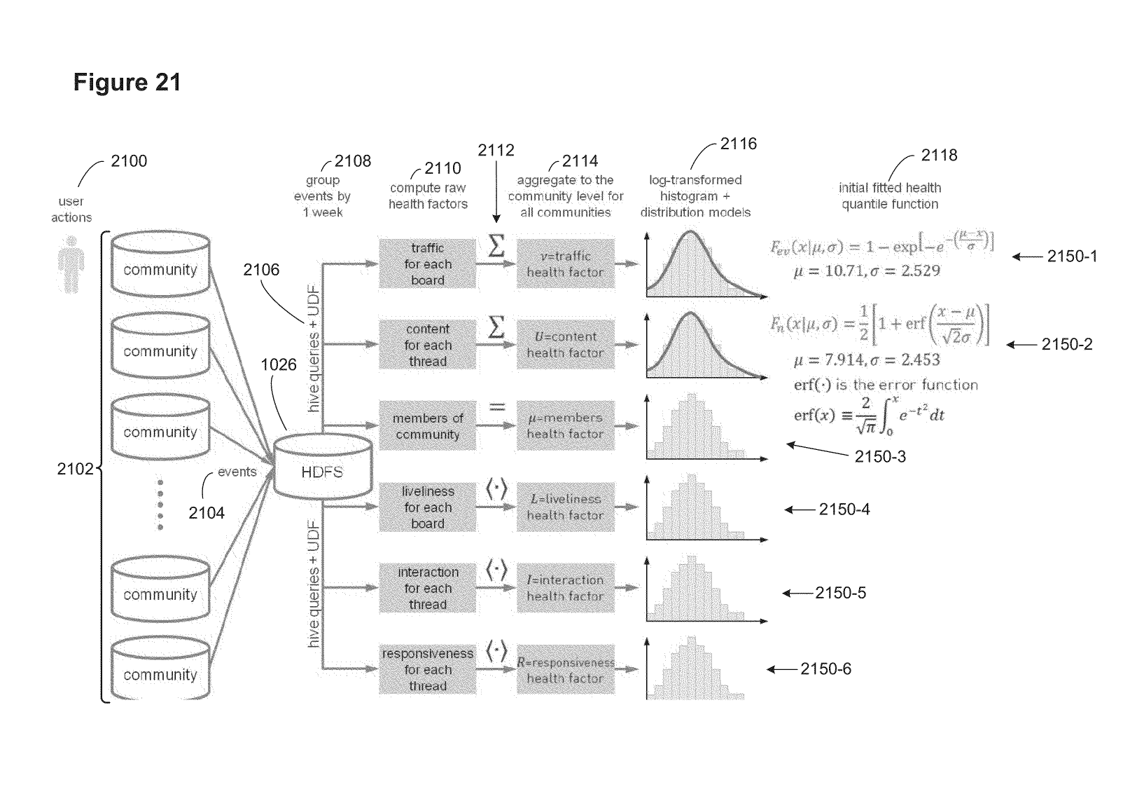

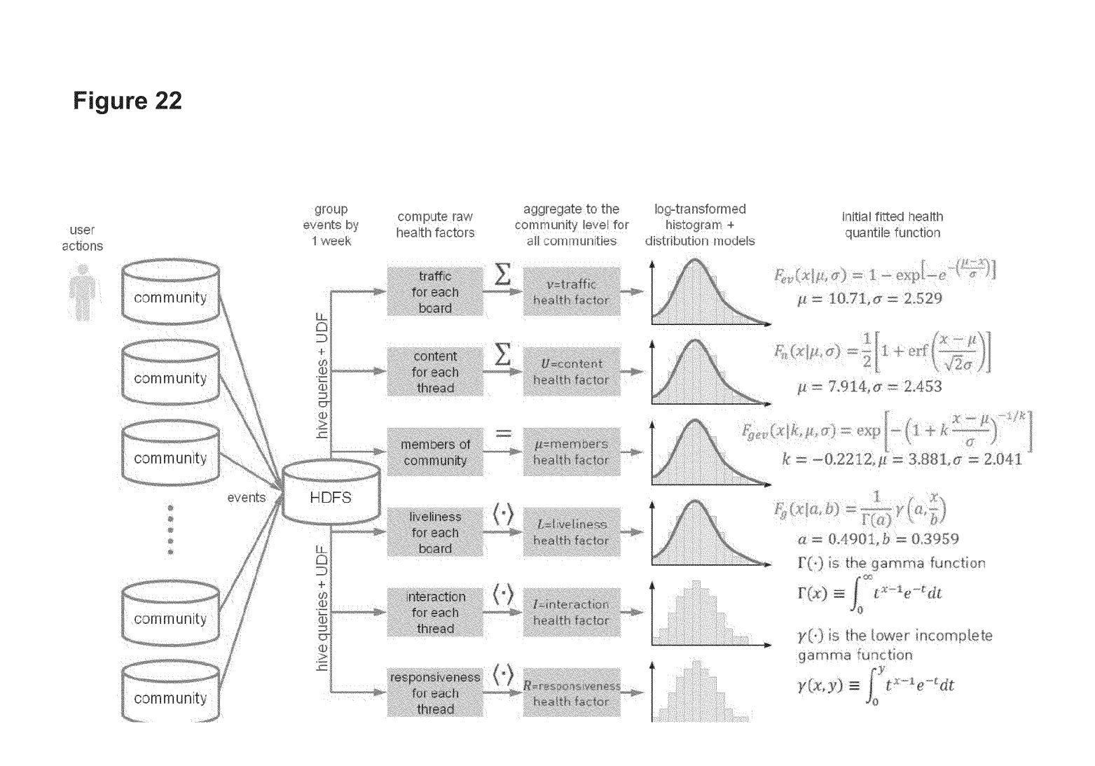

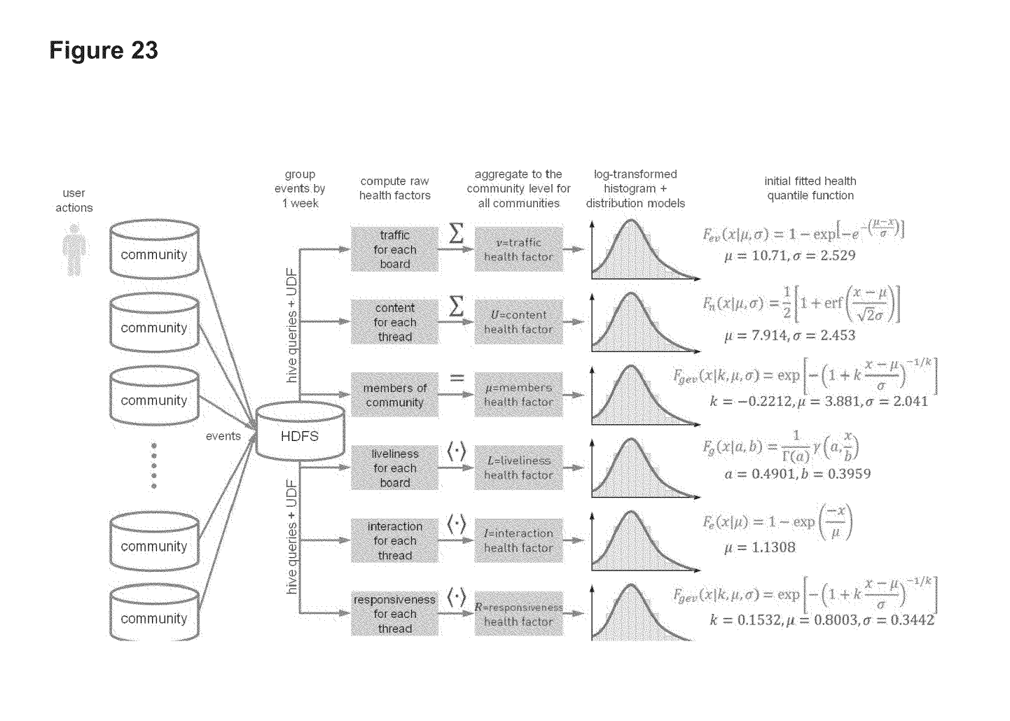

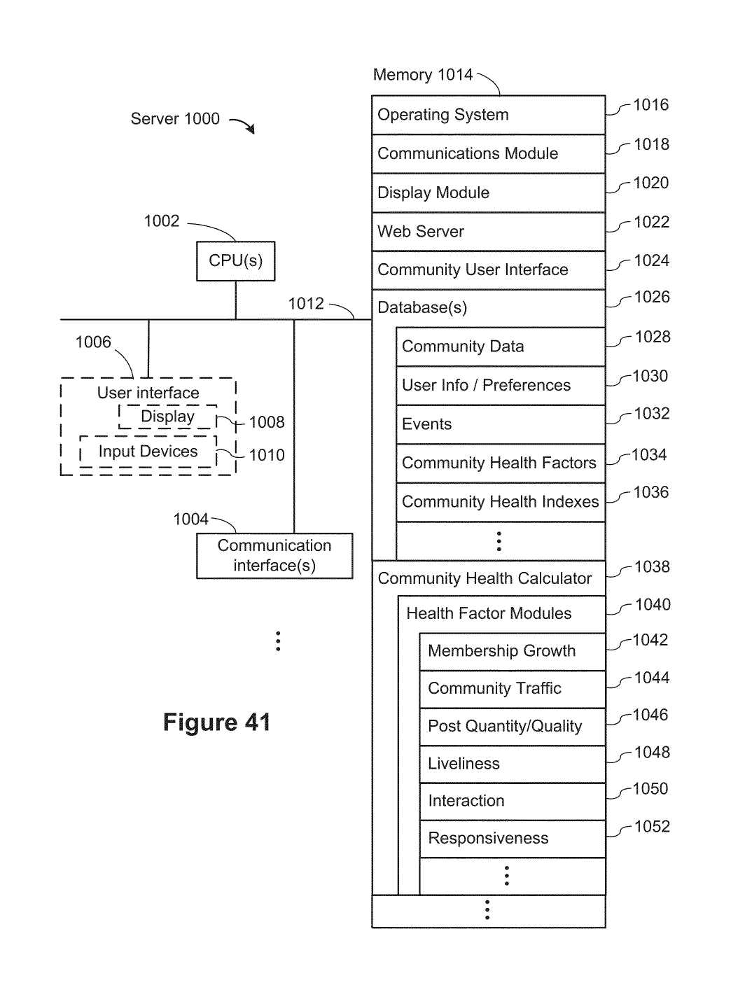

As illustrated in FIGS. 21-24, some implementations proceed in several steps to compute a score for each health factor. User actions 2100 with respect to online communities 2102 are stored as events 2104 in a database 1026, as described below with respect to FIG. 41. In some implementations, the database 1026 is a Hadoop distributed file system (HDFS), and the event data is extracted (2106) using Hive queries and one or more user defined functions. The event data is aggregated (2108) periodically, such as every week, every two weeks, or every month.

In these examples, each of the six rows 2150-1 to 2150-6 represents a different health factor. The first row 2150-1 corresponds to the calculations performed by the community traffic health factor module 1044. The second row 2150-2 corresponds to the post quantity/quality health factor module 1046. The third row 2150-3 corresponds to the membership growth health factor module 1042. The fourth row 2150-4 corresponds to the liveliness health factor module 1048. The fifth row 2150-5 corresponds to the interaction health factor module 1050. The sixth row 2150-6 corresponds to the responsiveness health factor module 1052.

In the first column 2110 in each row, raw health factors are computed for each board in each community. As noted above, the data is typically grouped into time periods such as weeks or months. The second column 2112 in each row illustrates how the data is aggregated for a community (e.g., aggregated over all boards within a community). The aggregation is performed differently based on the health factor. As illustrated, for the “traffic” and “content” health factors, the aggregation is performed by summing (illustrated with the symbol Σ). For the membership health factor, there is no aggregation because membership growth is typically at the community level (this is illustrated with the symbol=). Finally, the “liveliness,” “interaction,” and “responsiveness” health factors are aggregated by averaging (e.g., computing the mean average of all boards in a community). The averaging is illustrated by the symbol <•>. The third column 2114 in each row indicates the results of the aggregation specified in the second column 2112, and indicates a Greek or Roman letter used to refer to the aggregated calculation. For example, “L” is the aggregated liveliness health factor and μ is the community membership growth factor.

The fourth column 2116 in each row illustrates creating a log-transformed histogram of the data, which includes the data for many different time periods and/or many different communities. The histograms can be used to determine how well the factor for one community compares to a baseline average.

The fifth column 2118 in each row illustrates a statistical distribution model that may be applied. Although FIG. 21-24 illustrate specific values that may be used as parameters for these distributions, the parameter values are recomputed periodically based on the empirical data. In addition, other distribution models may be applied. Selection of both a model and the parameters for the model depend on data and the health factor.

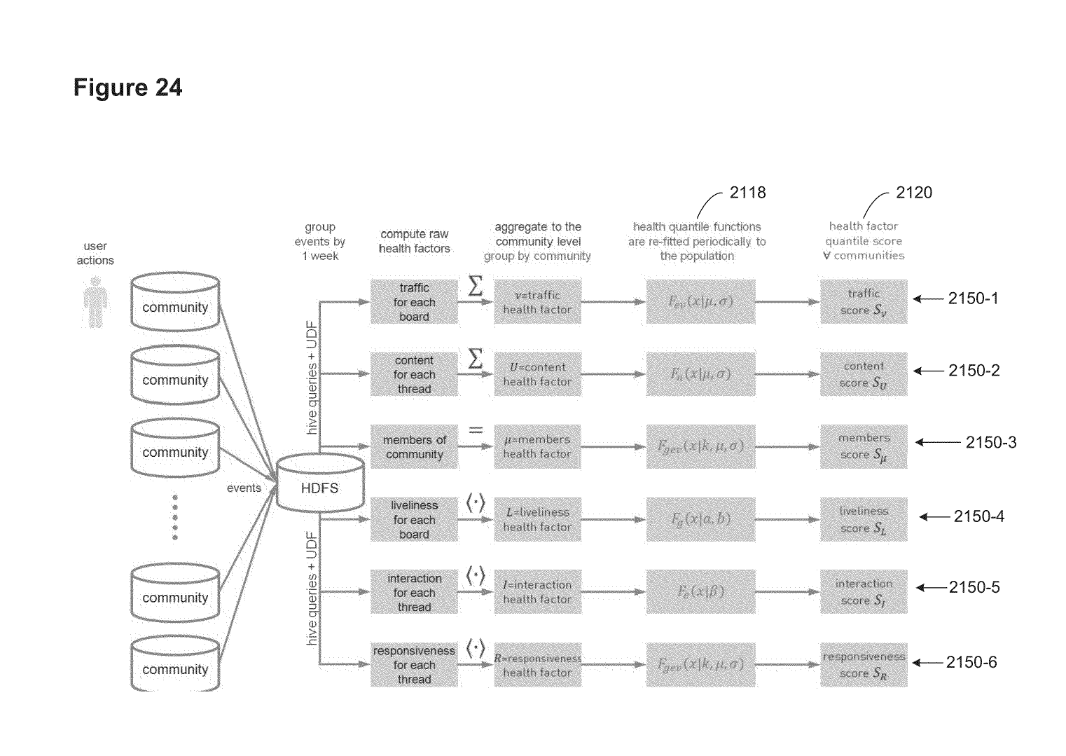

The last box 2120 in each row (see FIG. 24) illustrates how the distribution model for each factor is used to compute a health factor score that is a certain quantile (e.g., percentile or quartile). This effectively normalizes the various health factors by comparing the health factor for one community against all other communities (and compares different slices of time, such as weeks). For example, some implementations have health factor data for each week of each community's operation when the raw health factors are computed using events that are grouped into 1 week periods. The health factors are computed for each community, so for each health factor there are N raw health factor data points, where N=(# of communities)×(# of weeks since that communiy launched). This allows implementations to build a histogram for the distribution of possible values of each health factor.

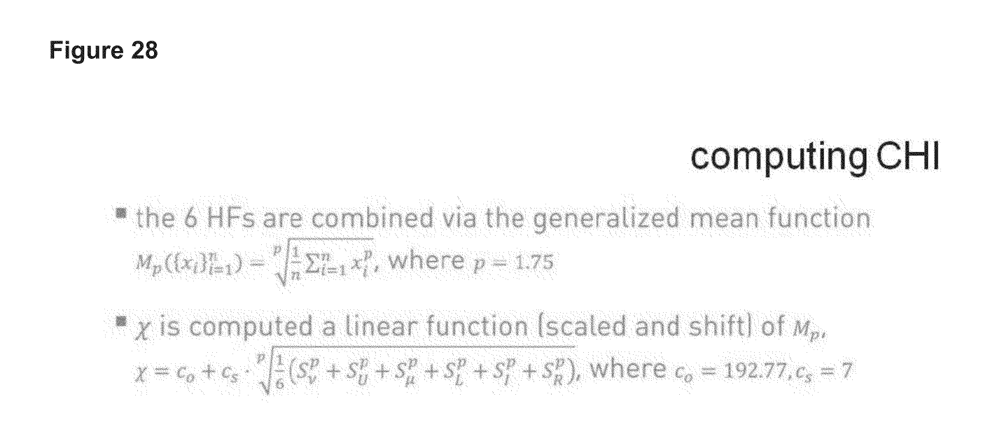

As illustrated in FIG. 28, the health factors can be combined in various ways. In some implementations, the factors are combined using a generalized mean function. In some implementations, the p-value for the generalized mean function is 1.75. In some implementations, the final CHI value is computed by scaling and shifting the combined value. This can be used, for example, to generated CHI values in a desired range (e.g., 0-1000). Some implementations combine the health factors in other ways, such as an arithmetic average or a weighted average (e.g., when certain of the health factors are considered more important than others).

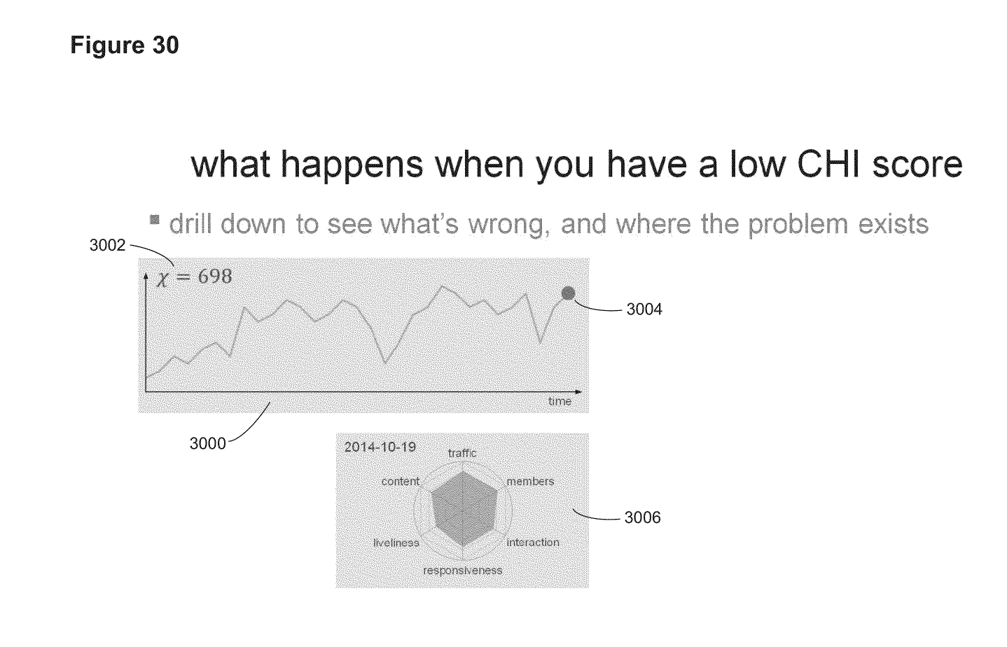

FIG. 30 provides a chart 3000 that displays the community health index over time for an online community. The dot 3004 indicates a particular point in time where the community health index value 3002 is 698. The community health compass 3006 illustrates how each of the six health factors contributes to the overall community health value 3002.

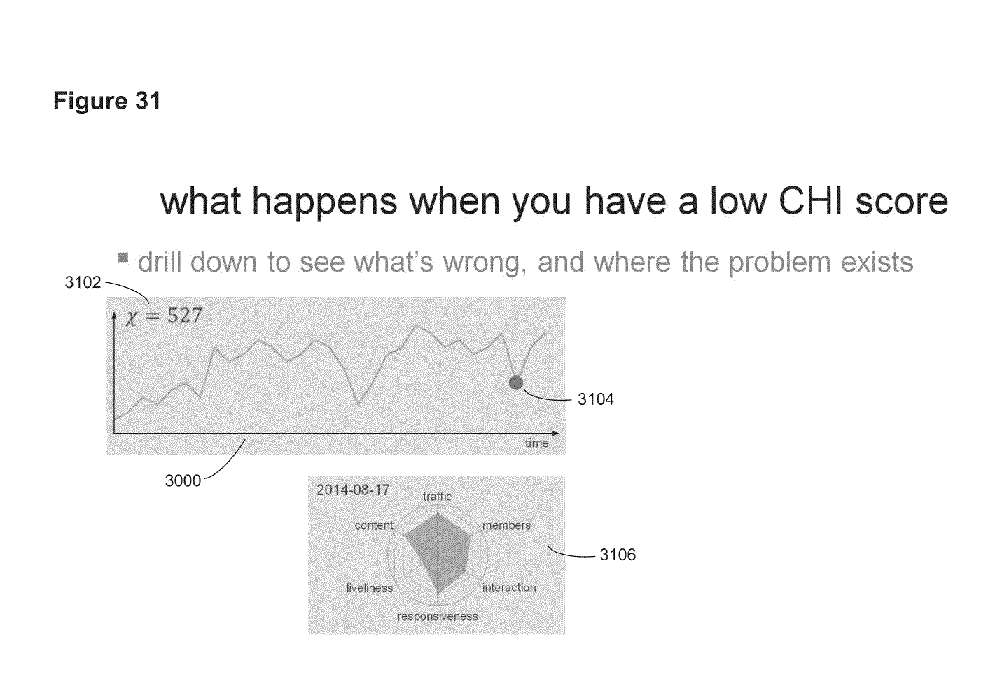

FIG. 31 shows the same chart 3000 displays the community health index over time, with a different dot 3104 selecting a different point in time. The dot 3104 indicates a particular point in time where the community health index value 3102 is 527. The community health compass 3106 illustrates how each of the six health factors contributes to the overall community health value 3102.

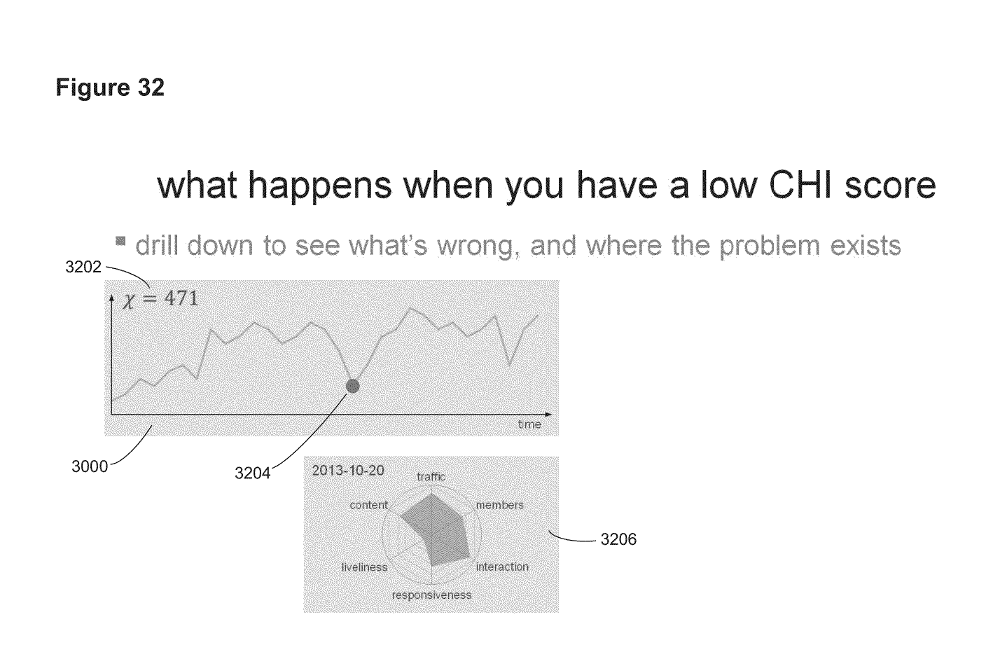

FIG. 32 shows the same chart 3000 displays the community health index over time, with a different dot 3204 selecting a different point in time. The dot 3204 indicates a particular point in time where the community health index value 3202 is 471. The community health compass 3206 illustrates how each of the six health factors contributes to the overall community health value 3202.

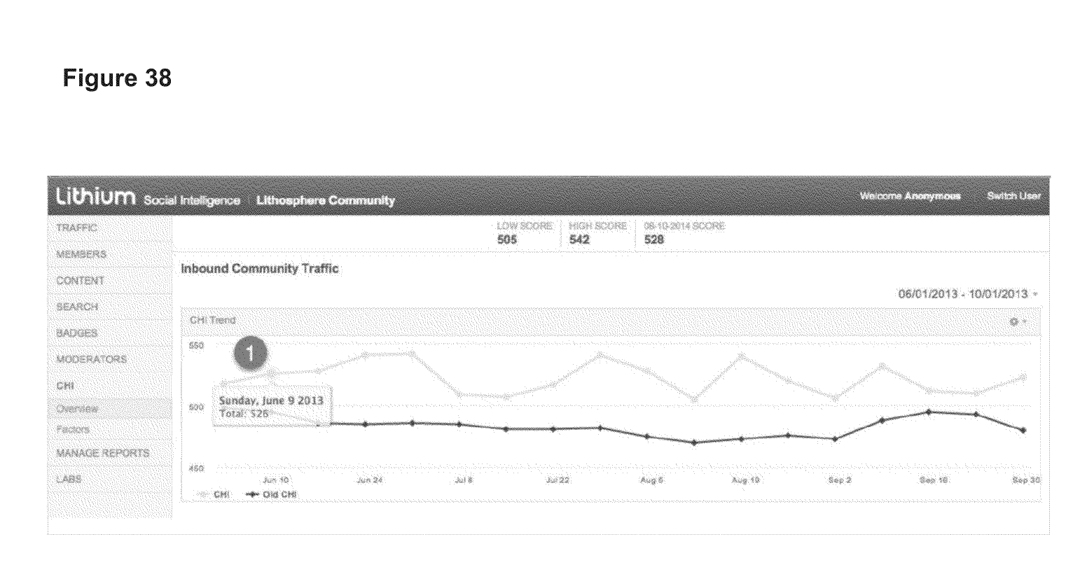

As illustrated in FIG. 38, some implementations are more sensitive to changes in the community health index compared to other models. Some disclosed CHI calculations are more sensitive to change because alternative versions of CHI had a smoothing step that filtered out transient changes. With filtering, only persistent changes affect a CHI score. For example, if there is a big marketing event that drives huge community usage and participation in 1 week, but the change does not last, the CHI score will not change under the older alternative implementations. Some implementations enable people to see the changes, even if it rises for one week and falls back down the next week.

FIG. 41 is a block diagram illustrating a server 1000 that may be used in disclosed implementations. A typical server is part of a server system that includes many individual servers 1000, which may be hundreds or thousands, and the servers are not necessarily geographically collocated. A server 1000 typically includes one or more processing units (CPUs) 1002 for executing modules, programs, or instructions stored in the memory 1014 and thereby performing processing operations; one or more network or other communications interfaces 1004; memory 1014; and one or more communication buses 1012 for interconnecting these components. The communication buses 1012 may include circuitry (sometimes called a chipset) that interconnects and controls communications between system components. In some implementations, a server 1000 includes a user interface 1006, which may include a display device 1008 and one or more input devices 1010, such as a keyboard and a mouse.

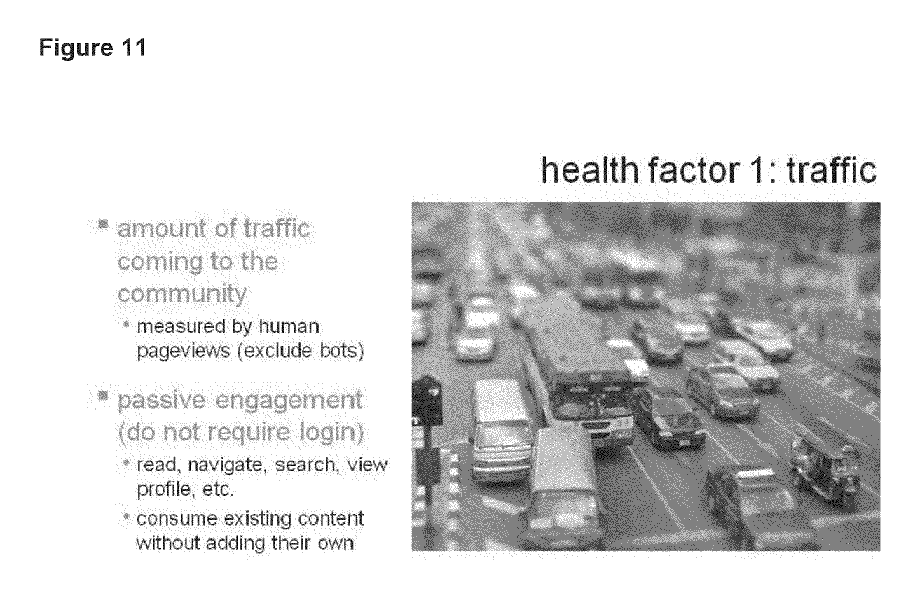

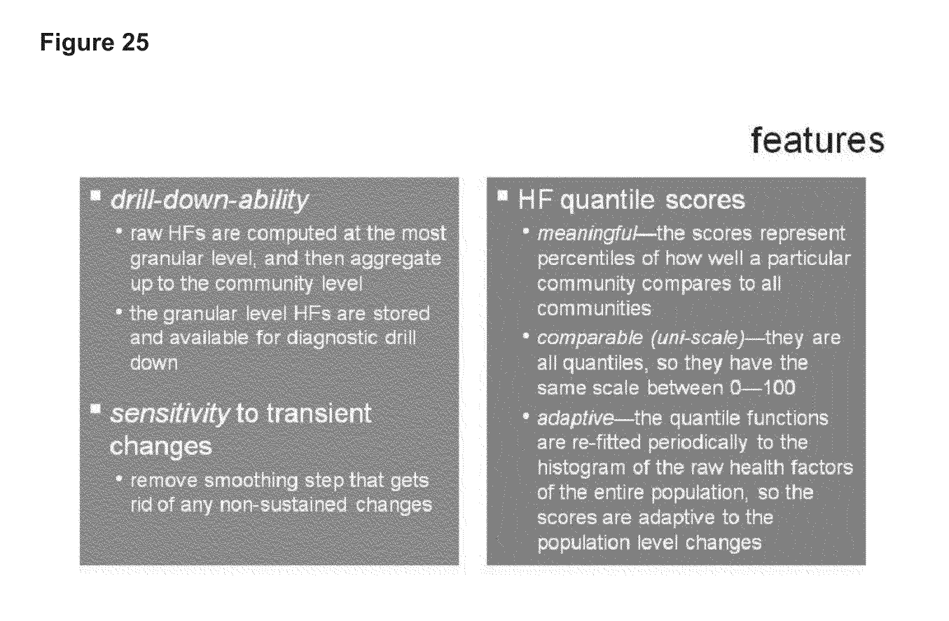

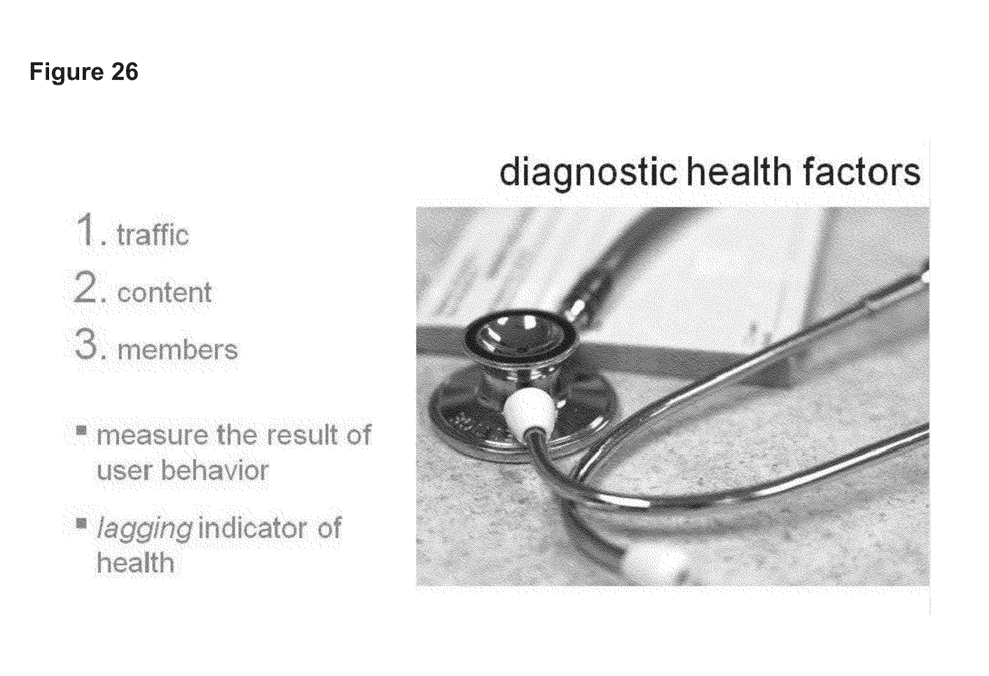

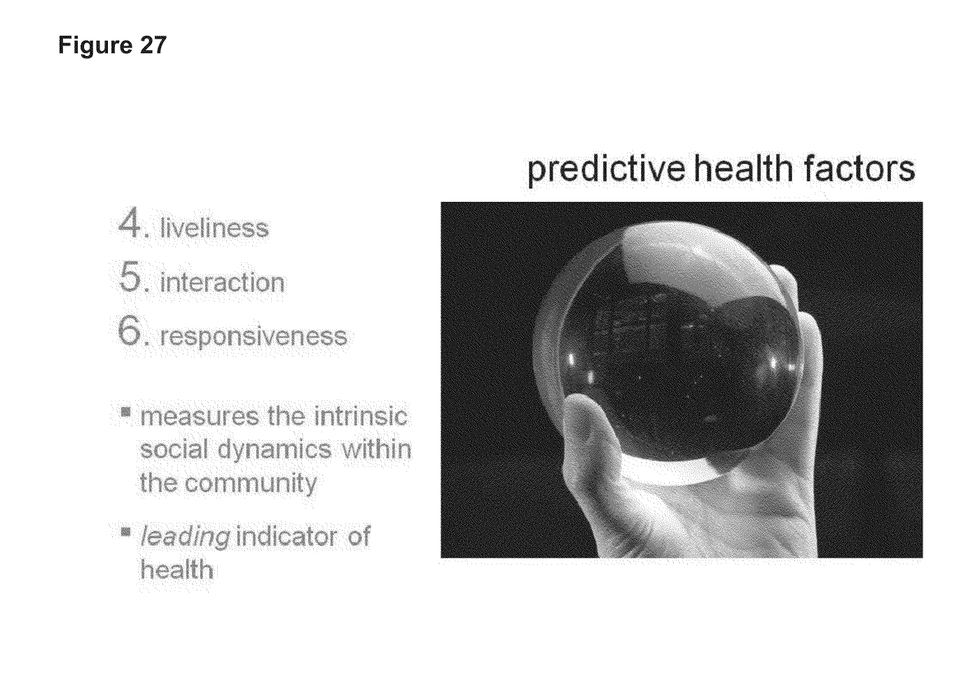

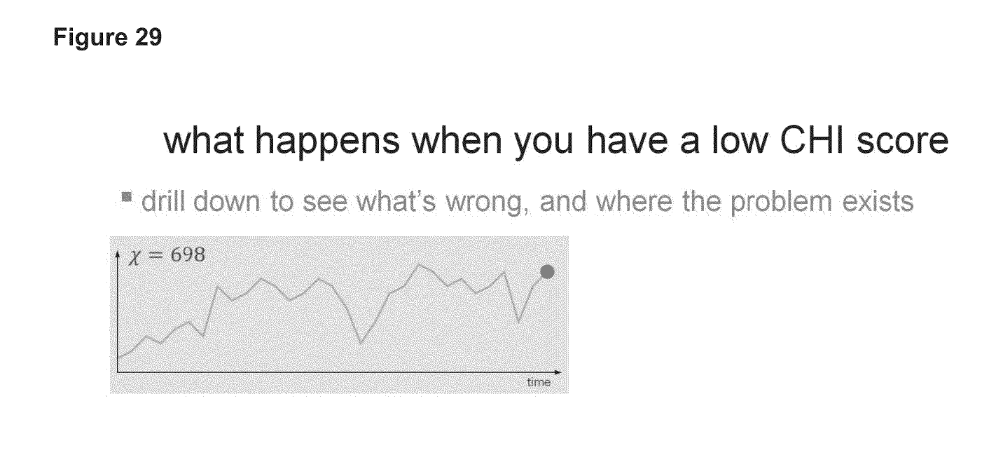

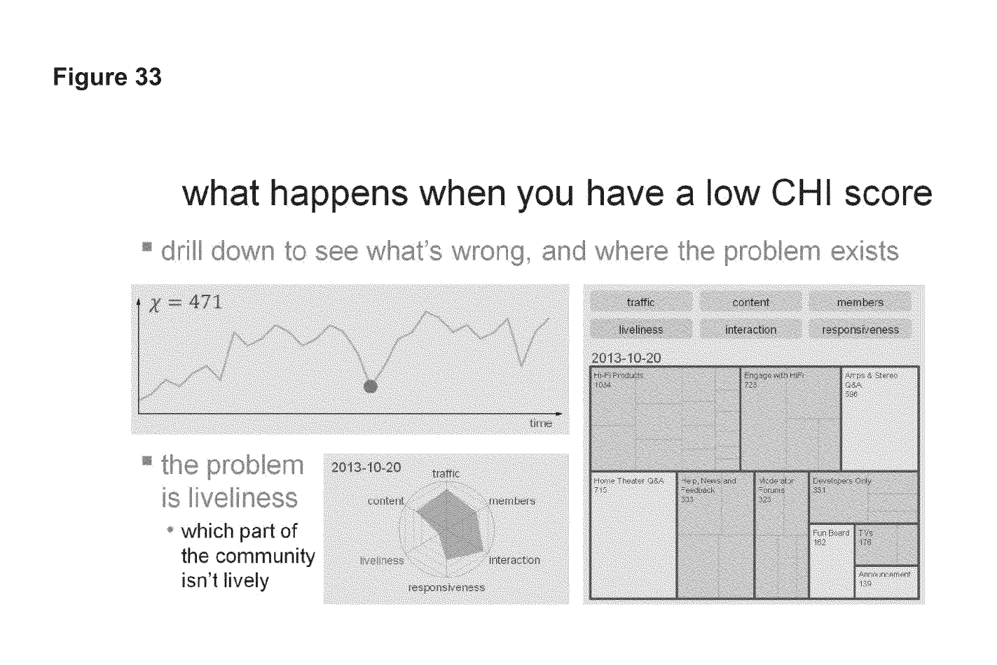

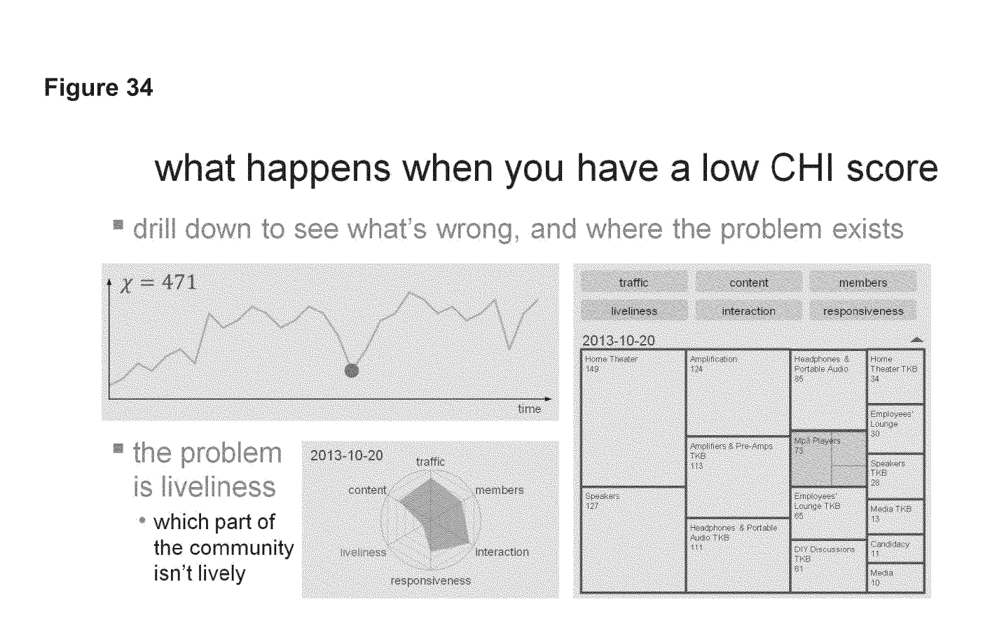

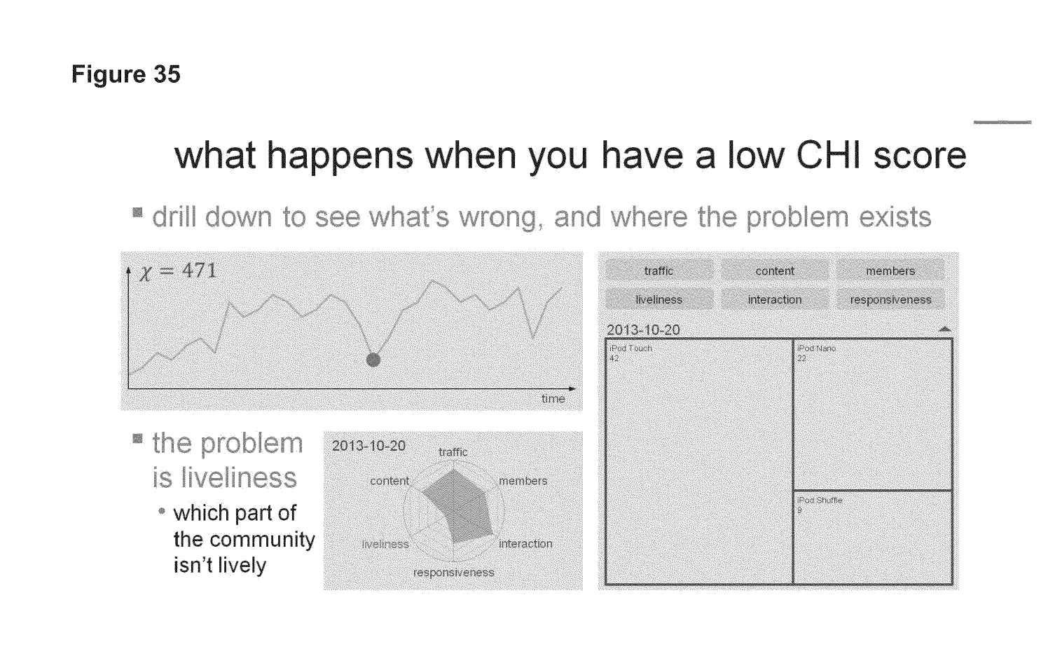

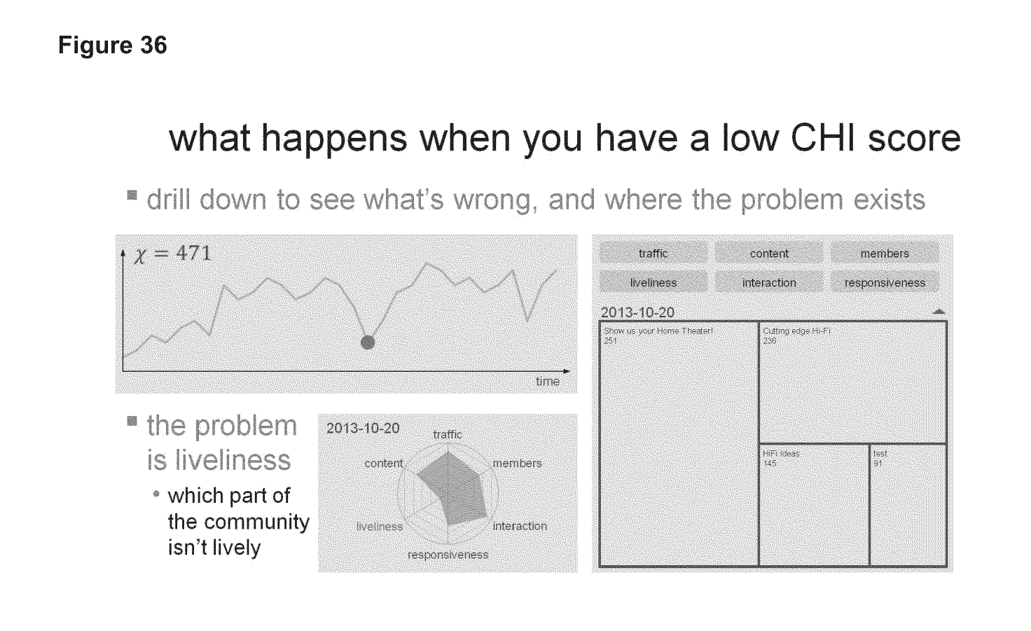

In some implementations, the memory 1014 includes high-speed random access memory, such as DRAM, SRAM, DDR RAM, or other random access solid state memory devices. In some implementations, the memory 1014 includes non-volatile memory, such as one or more magnetic disk storage devices, optical disk storage devices, flash memory devices, or other non-volatile solid state storage devices. In some implementations, the memory 1014 includes one or more storage devices remotely located from the CPU(s) 1002. The memory 1014, or alternately the non-volatile memory device(s) within the memory 1014, comprises a non-transitory computer readable storage medium. In some implementations, the memory 1014, or the computer readable storage medium of the memory 1014, stores the following programs, modules, and data structures, or a subset thereof:
an operating system 1016, which includes procedures for handling various basic system services and for performing hardware dependent tasks;
a communications module 1018, which is used for connecting the server 1000 to other computers via the one or more communication network interfaces 1004 (wired or wireless), an internal network or bus, or other communication networks, such as the Internet, other wide area networks, local area networks, metropolitan area networks, and so on;
a display module 1020, which receives input from the one or more input devices 1010, and generates user interface elements for display on the display device 1008;
one or more web servers 1022, which receive requests from computing devices 300, and return responsive web pages, resources, links, and/or data. In some implementations, each request is logged in the database 1026 (e.g., in the events 1032);
a community user interface 1024, which is provided to computing devices 300 to access one or more online communities. In some implementations, the community user interface 1024 is provided as a set of web pages, delivered as requested. In some implementations, the community user interface 1024 is provided as an application, which is downloaded and run on computing devices 300. In some implementations, the community user interface 1024 is provided as either a set of web pages or an application, and individual users can choose which to use. As known by one of skill in the art, an online community typically provides discussion forums on various topics, knowledge bases, access to experts, calendars of events, and so on;
one or more databases 1026, which store a variety of data related to online communities. In some implementations, the databases include SQL databases (e.g., mySQL) as well as large scale distributed databases, such as Hadoop's HDFS;
the databases 1026 store community data 1028, such as the content and metadata for online forums and discussion boards, knowledge bases, and other data needed by a community user interface 1024 to provide an online social community;
the databases 1026 store user information and preferences 1030, such as user IDs, encrypted passwords, user settings and preferences, and so on;
the databases 1026 store a log of events 1032, which track each user interaction with an online community, as described above with respect to FIG. 10. Each user action creates an event that is stored in the log of events 1032. The data for each event in the event log 1032 includes contextual information about the user action, such as the server request ID, the session ID, the IP address, the user agent, the requested URL, various query parameters, referrers, the community ID, the action ID, a timestamp, an indication of where within the community the action was taken, who took the action, the target object of that action, who was the receiver of the action, and so on;
the databases 1026 store the computed community health factors 1034, as described below with respect to the health factor modules 1040. The community health factors 1034 are computed periodically (e.g., weekly or monthly), so implementations typically store the computed health factors 1034 each time they are computed. This provides the ability to perform historical analysis of how the factors have changed;
the databases 1026 store the computed community health index (CHI) values 1036 as well. As illustrated above in FIG. 28, the community health index 1036 is computed as a function of a plurality of the community health factors 1034. Like the health factors 1034, the community health index 1036 is computed periodically, typically at the same time the individual health factors are computed, and the computed health index 1036 is stored in the databases 1026 each time, thus providing for time sequence analysis, as illustrated in FIGS. 29-36; and
a community health calculator 1038, as illustrated above in FIGS. 10-28. As illustrated in these figures, the community health calculator uses data in the event log 1032 to compute multiple raw health factor scores. The raw scores are aggregated and normalized using an appropriate statistical distribution module. This enables each of the factors to be compared against the same factors for other online communities. Then, the community health calculator 1038 combines the individual health factors 1034 to compute an overall community health index 1036. In some implementations, the community health calculator 1038 includes a plurality of health factor modules 1040, with each health factor module 1040 computing one or more specific health factors 1034.

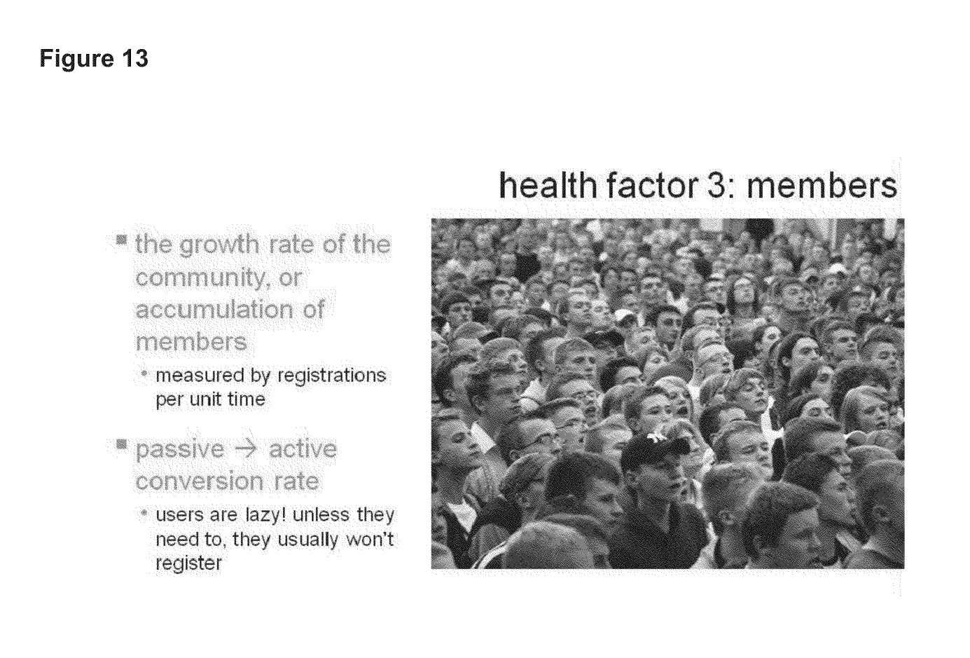

In some implementations, the health factor modules 1040 include a membership growth health factor module 1042, which computes the overall membership growth of an online social community. This is illustrated above in FIGS. 13 and 14.

In some implementations, the health factor modules 1040 include a community traffic health factor module 1044, which computes the number of human page views for an online social community. This is illustrated above in FIGS. 10, 11, and 14.

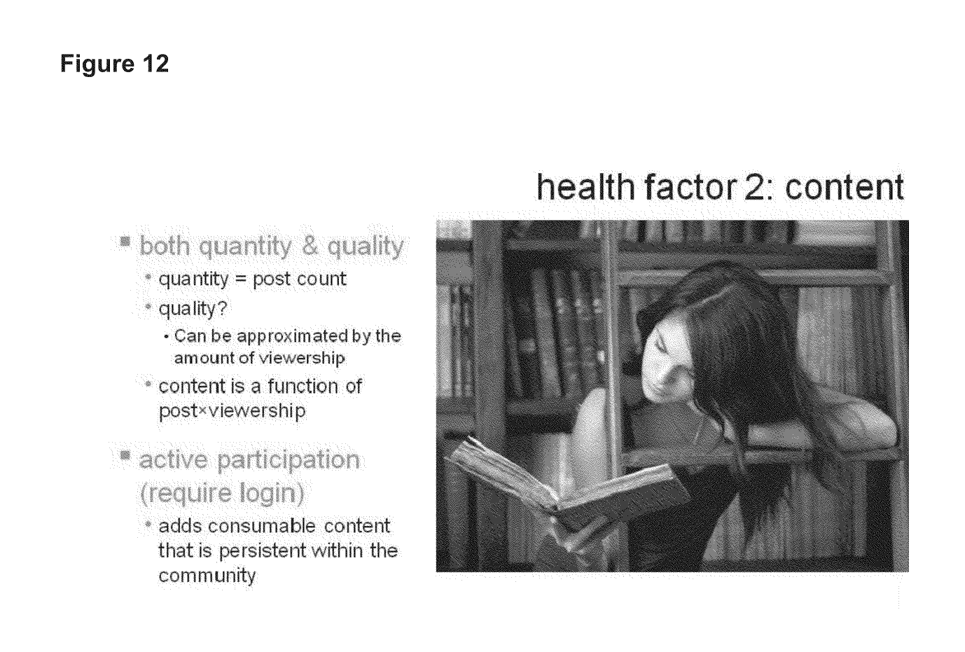

In some implementations, the health factor modules 1040 include a post content health factor module 1046, which measures both the quantity and the quality of posts to an online social community. This is illustrated above in FIGS. 12 and 14.

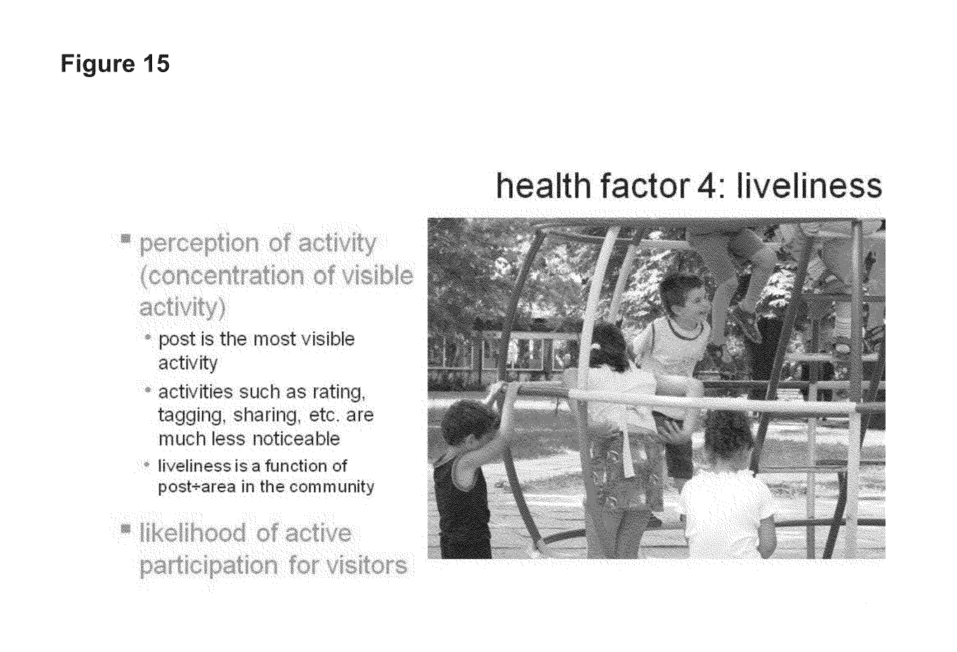

In some implementations, the health factor modules 1040 include a liveliness health factor module 1048, which measures perception of activity level in an online social community. This is illustrated above in FIGS. 15 and 16.

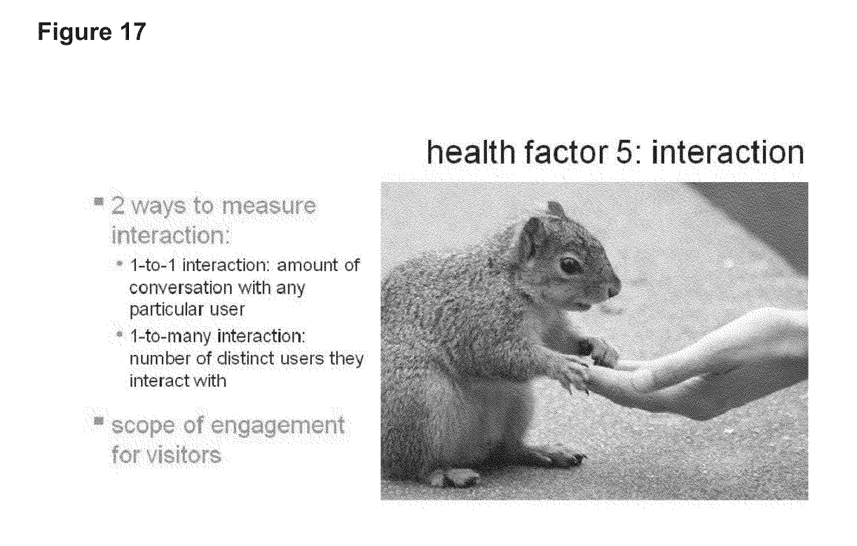

In some implementations, the health factor modules 1040 include an interaction health factor module 1050, which measures the scope of engagement for an online social community. This is illustrated above in FIGS. 17 and 18.

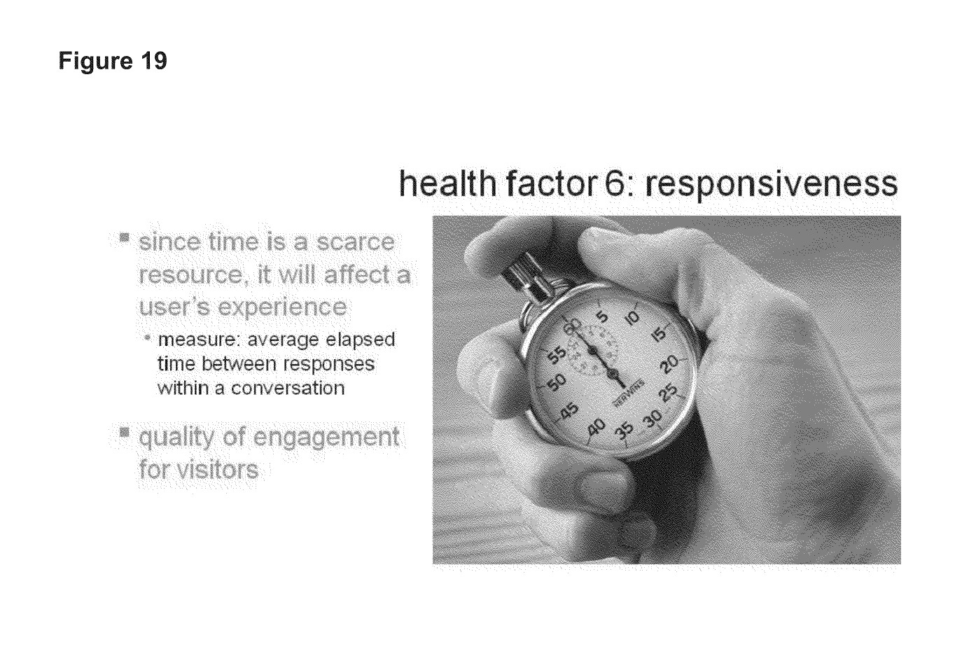

In some implementations, the health factor modules 1040 include a responsiveness health factor module 1052, which measures the quality of engagement for an online social community. This is illustrated above in FIGS. 19 and 20.

Each of the above identified elements in FIG. 41 may be stored in one or more of the previously mentioned memory devices. Each executable program, module, or procedure corresponds to a set of instructions for performing a function described above. The above identified modules or programs (i.e., sets of instructions) need not be implemented as separate software programs, procedures or modules, and thus various subsets of these modules may be combined or otherwise re-arranged in various implementations. In some implementations, the memory 1014 may store a subset of the modules and data structures identified above. Furthermore, the memory 1014 may store additional modules or data structures not described above.

Although FIG. 41 illustrates a server 1000, FIG. 41 is intended more as functional illustration of the various features that may be present in a set of one or more servers rather than as a structural schematic of the implementations described herein. In practice, and as recognized by those of ordinary skill in the art, items shown separately could be combined and some items could be separated. The actual number of servers used to implement these features, and how features are allocated among them, will vary from one implementation to another, and may depend in part on the amount of data traffic that the system must handle during peak usage periods as well as during average usage periods.

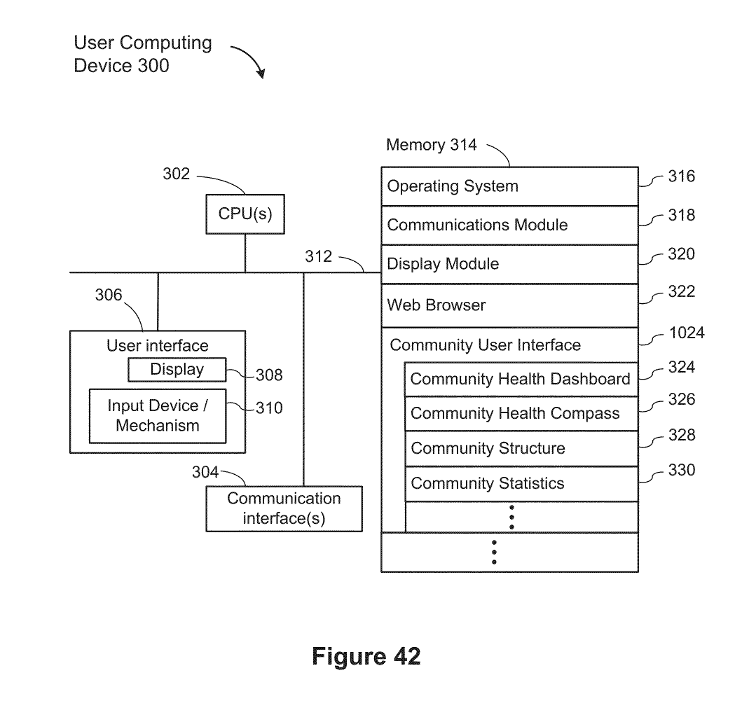

FIG. 42 is a block diagram illustrating a device 300 that a user uses to view community health data or to access an online community. A device is also referred to as a computing device or a client device, which may be a tablet computer, a laptop computer, a smart phone, a desktop computer, a PDA, or other computing device. A client device 300 typically includes one or more processing units (CPUs) 302 for executing modules, programs, or instructions stored in the memory 314 and thereby performing processing operations; one or more network or other communications interfaces 304; memory 314; and one or more communication buses 312 for interconnecting these components. The communication buses 312 may include circuitry (sometimes called a chipset) that interconnects and controls communications between system components. A client device 300 includes a user interface 306 comprising a display device 308 and one or more input devices or mechanisms 310. In some implementations, the input device/mechanism includes a keyboard and a mouse; in some implementations, the input device/mechanism includes a “soft” keyboard, which is displayed as needed on the display device 308, enabling a user to “press keys” that appear on the display 308.

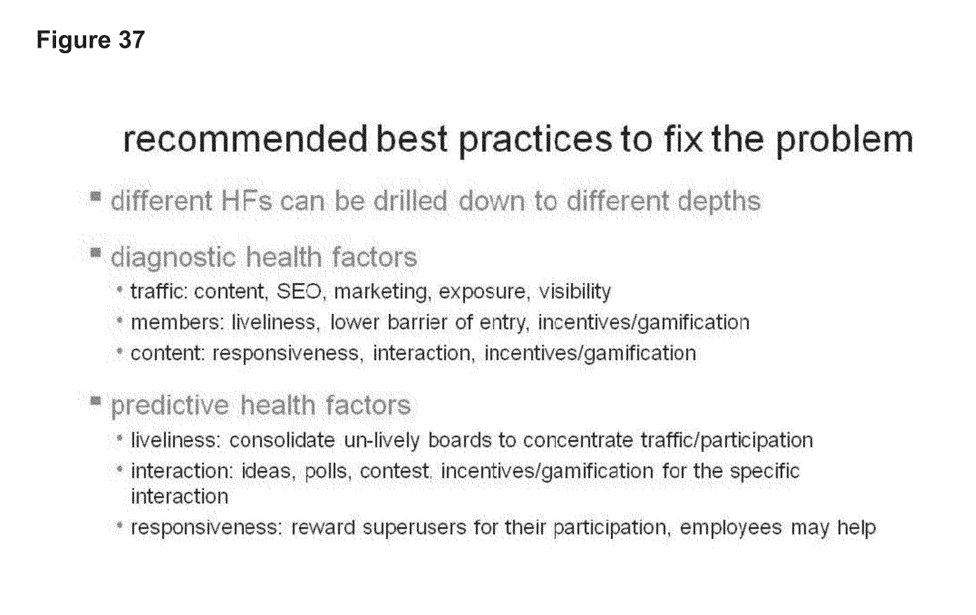

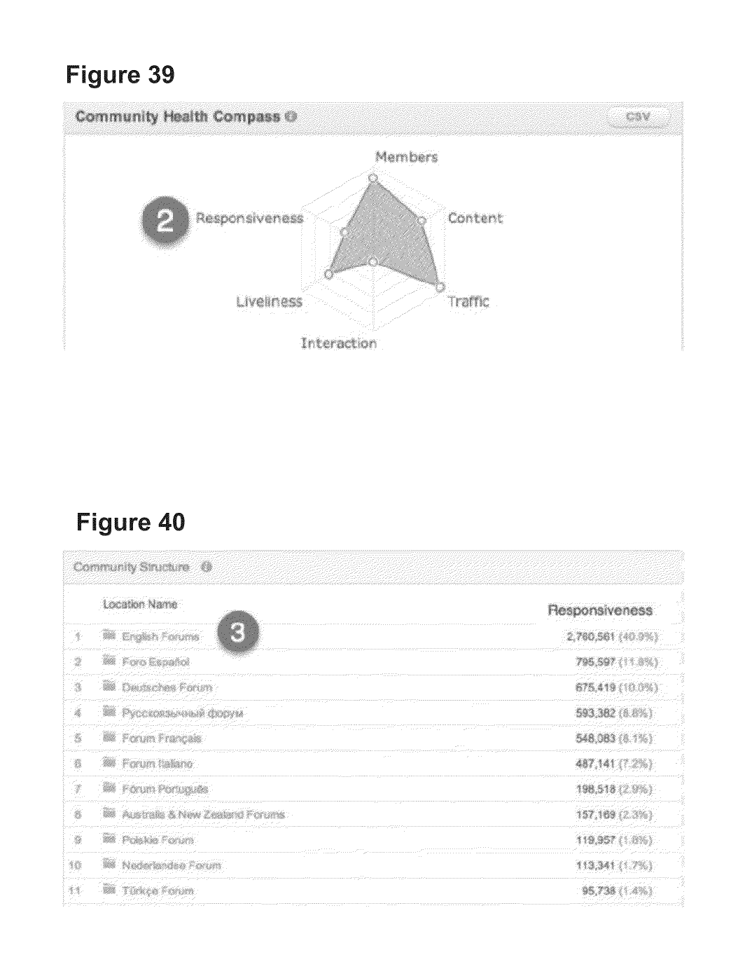

In some implementations, the memory 314 includes high-speed random access memory, such as DRAM, SRAM, DDR RAM, or other random access solid state memory devices. In some implementations, the memory 314 includes non-volatile memory, such as one or more magnetic disk storage devices, optical disk storage devices, flash memory devices, or other non-volatile solid state storage devices. In some implementations, the memory 314 includes one or more storage devices remotely located from the CPU(s) 302. The memory 314, or alternately the non-volatile memory device(s) within the memory 314, comprises a non-transitory computer readable storage medium. In some implementations, the memory 314, or the computer readable storage medium of the memory 314, stores the following programs, modules, and data structures, or a subset thereof:
an operating system 316, which includes procedures for handling various basic system services and for performing hardware dependent tasks;
a communications module 318, which is used for connecting the client device 300 to other computers and devices via the one or more communication network interfaces 204 (wired or wireless) and one or more communication networks, such as the Internet, other wide area networks, local area networks, metropolitan area networks, and so on;
a display module 320, which receives input from the one or more input devices 310, and generates user interface elements for display on the display device 308;
a web browser 322, which enables a user to communicate over a network (such as the Internet) with remote computers or devices; and
a community user interface 1024, which is typically displayed as a set of web pages in the web browser 322. In some implementations, the community user interface 322 includes a community health dashboard 324, a community health compass 326, a display of community structure 328, and/or community statistics 330. Some elements of a community user interface are illustrated in FIGS. 29-40.

Each of the above identified executable modules, applications, or sets of procedures may be stored in one or more of the previously mentioned memory devices and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 314 stores a subset of the modules and data structures identified above. Furthermore, the memory 314 may store additional modules or data structures not described above.

Although FIG. 42 shows a client device 300, FIG. 42 is intended more as a functional description of the various features that may be present rather than as a structural schematic of the implementations described herein. In practice, and as recognized by those of ordinary skill in the art, items shown separately could be combined and some items could be separated.

The terminology used in the description of the implementations herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations described herein were chosen and described in order to best explain the principles of the invention and its practical applications, to thereby enable others skilled in the art to best utilize the invention and various implementations with various modifications as are suited to the particular use contemplated.

What is claimed is:

1. A method of measuring the health of online communities, comprising:
at a computing device having one or more processors and memory storing one or more programs configured for execution by the one or more processors:
computing a plurality of health factors for an online community, wherein each health factor is computed based on historical data of the online community, and each health factor measures human interaction with the online community;
normalizing each of the health factors;
combining the health factors to compute a community health index; and
displaying the community health index to a user on a display associated with the computing device, thereby enabling the user to predict the future health of the online community.

2. The method of claim 1, wherein the plurality of health factors are selected from the group consisting of: (1) growth in membership of the online community; (2) human page views of web pages for the online community; (3) quantity and quality of posts to the online community; (4) liveliness of the online community; (5) interaction with the online community; and (6) responsiveness of the online community.

3. The method of claim 1, wherein the plurality of health factors includes a health factor that tracks a growth rate of members registered with the online community.

4. The method of claim 1, wherein the plurality of health factors includes a health factor that tracks a number of pages views of web pages in the online community.

5. The method of claim 1, wherein the plurality of health factors includes a health factor that estimates quantity and quality of posts to the online community by computing a product of a first number representing number of posts to the online community and a second number representing number of page views of web pages in the online community.

6. The method of claim 1, wherein the plurality of health factors includes a health factor that measures liveliness of the online community, and wherein liveliness is computed as a function whose argument is number of posts to the online community divided by number of boards in the online community.

7. The method of claim 6, wherein the function includes a second argument that represents an expected number of posts per board during a specified unit of time.

8. The method of claim 1, wherein the plurality of health factors includes a health factor that measures interaction of the online community, and wherein interaction is computed as an aggregated function of posting threads, including both the number of replies in each thread and the number of distinct users in each thread.

9. The method of claim 1, wherein the plurality of health factors includes a health factor that measures responsiveness of the online community, and wherein responsiveness is computed as an average response time in posting threads.

10. The method of claim 1, wherein normalizing each of the health factors includes applying a statistical distribution model.

11. The method of claim 1, wherein normalizing each of the health factors includes computing a quantile for each health factor that ranks the health factor for the online community against other online communities.

12. The method of claim 1, wherein combining the health factors to compute a community health index uses a generalized mean function of the plurality of health factors.

13. The method of claim 1, wherein combining the health factors to compute a community health index uses a weighted average of the plurality of health factors.

14. The method of claim 1, wherein combining the health factors to compute a community health index scales the computed value to a specific range.

15. The method of claim 1, wherein displaying the community health index includes providing a user interface shat shows both the community health index and the individual health factors that were used to compute the community health index.

16. The method of claim 1, wherein displaying the community health index includes providing a user interface shat shows a graph of how the community health index has changed over time.

17. A computing device, comprising:
one or more processors;
memory; and
one or more programs stored in the memory configured for execution by the one or more processors, the one or more programs comprising instructions for:
computing a plurality of health factors for an online community, wherein each health factor is computed based on historical data of the online community, and each health factor measures human interaction with the online community;
normalizing each of the health factors;
combining the health factors to compute a community health index; and
displaying the community health index to a user on a display associated with the computing device, thereby enabling the user to predict the future health of the online community.

18. The computing device of claim 17, wherein the plurality of health factors includes a health factor that estimates quantity and quality of posts to the online community by computing a product of a first number representing number of posts to the online community and a second number representing number of page views of web pages in the online community.

19. The computing device of claim 17, wherein the plurality of health factors includes a health factor that measures interaction of the online community, and wherein interaction is computed as an aggregated function of posting threads, including both the number of replies in each thread and the number of distinct users in each thread.

20. A non-transitory computer readable storage medium storing one or more programs configured for execution by a computing device having one or more processors and memory, the one or more programs comprising instructions for:
computing a plurality of health factors for an online community, wherein each health factor is computed based on historical data of the online community, and each health factor measures human interaction with the online community;
normalizing each of the health factors;
combining the health factors to compute a community health index; and
displaying the community health index to a user on a display associated with the computing device, thereby enabling the user to predict the future health of the online community.
